(19) United States
(12) Patent Application Publication
(10) Pub. No.: US 2025/0377765 A1
(43) Pub. Date: Dec. 11, 2025

(54) PHYSICAL ACTIVITY USER INTERFACES

(71) Applicant: Apple Inc., Cupertino, CA (US)

(72) Inventors: Brett L. LAREAU, San Jose, CA (US); Fabiana DI MASO, Morgan Hill, CA (US); Jonathan J. NACHUM, Santa Clara, CA (US)

(21) Appl. No.: 18/896,661

(22) Filed: Sep. 25, 2024

Related U.S. Application Data
(60) Provisional application No. 63/657,928, filed on Jun. 9, 2024.

(51) Int. Cl. G06F 3/0484; A63B 24/00; G06F 3/01

(52) U.S. Cl. CPC G06F 3/0484; A63B 24/0062; G06F 3/011; A63B 2024/0068

(57) ABSTRACT

The present disclosure generally relates to techniques for managing physical activity user interfaces.

### CROSS-REFERENCE TO RELATED APPLICATIONS

This application claims priority to U.S. Patent Application Ser. No. 63/657,928, entitled “PHYSICAL ACTIVITY USER INTERFACES,” filed on Jun. 9, 2024, the entire contents of which are hereby incorporated by reference in their entireties.

### FIELD

The present disclosure relates generally to computer user interfaces, and more specifically to techniques for managing physical activity user interfaces.

### BACKGROUND

Devices detect users performing physical activities and update user interfaces according to the physical activities detected. This allows users to review the physical activities they have performed.

### BRIEF SUMMARY

Some techniques for managing physical activity user interfaces using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing physical activity user interfaces. Such methods and interfaces optionally complement or replace other methods for managing physical activity user interfaces. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system that is in communication with one or more activity sensors and one or more one or more input devices: during a first time period, operating in a first mode of operation that includes tracking a plurality of types of physical activities, including tracking a first type of activity and tracking a second type of activity, of a user of the computer system, including: detecting, via the one or more activity sensors, first activity data corresponding to physical activities of the user of the computer system while the computer system is operating in the first mode of operation; and updating, based on the first activity data, activity metrics for the plurality of types of physical activities, including updating a first activity metric and updating a second activity metric; while operating in the first mode of operation, receiving, via one or more input devices, one or more user inputs corresponding to a request to transition to a second mode of operation, different from the first mode of operation; in response to receiving the one or more user inputs corresponding to the request to transition to the second mode of operation, transitioning to operating in the second mode of operation that does not include tracking the plurality of types of physical activities of the user of the computer system; during a second time period that is different from the first time period, operating in the second mode of operation that does not include tracking the plurality of types of physical activities of the user of the computer system; while operating in the second mode of operation, detecting an end of a period of time; and in response to detecting the end of the period of time, transitioning to operating in the first mode of operation that includes tracking the plurality of types of physical activities of the user of the computer system.

In accordance with some embodiments, a non-transitory computer-readable storage medium is described. The non-transitory computer-readable storage medium stores one or more programs configured to be executed by one or more processors of a computer system that is in communication with one or more activity sensors and one or more one or more input devices, the one or more programs including instructions for: during a first time period, operating in a first mode of operation that includes tracking a plurality of types of physical activities, including tracking a first type of activity and tracking a second type of activity, of a user of the computer system, including: detecting, via the one or more activity sensors, first activity data corresponding to physical activities of the user of the computer system while the computer system is operating in the first mode of operation; and updating, based on the first activity data, activity metrics for the plurality of types of physical activities, including updating a first activity metric and updating a second activity metric; while operating in the first mode of operation, receiving, via one or more input devices, one or more user inputs corresponding to a request to transition to a second mode of operation, different from the first mode of operation; in response to receiving the one or more user inputs corresponding to the request to transition to the second mode of operation, transitioning to operating in the second mode of operation that does not include tracking the plurality of types of physical activities of the user of the computer system; during a second time period that is different from the first time period, operating in the second mode of operation that does not include tracking the plurality of types of physical activities of the user of the computer system; while operating in the second mode of operation, detecting an end of a period of time; and in response to detecting the end of the period of time, transitioning to operating in the first mode of operation that includes tracking the plurality of types of physical activities of the user of the computer system.

In accordance with some embodiments, a transitory computer-readable storage medium is described. The transitory computer-readable storage medium stores one or more programs configured to be executed by one or more processors of a computer system that is in communication with one or more activity sensors and one or more one or more input devices, the one or more programs including instructions for: during a first time period, operating in a first mode of operation that includes tracking a plurality of types of physical activities, including tracking a first type of activity and tracking a second type of activity, of a user of the computer system, including: detecting, via the one or more activity sensors, first activity data corresponding to physical activities of the user of the computer system while the computer system is operating in the first mode of operation; and updating, based on the first activity data, activity metrics for the plurality of types of physical activities, including updating a first activity metric and updating a second activity metric; while operating in the first mode of operation, receiving, via one or more input devices, one or more user inputs corresponding to a request to transition to a second mode of operation, different from the first mode of operation; in response to receiving the one or more user inputs corresponding to the request to transition to the second mode of operation, transitioning to operating in the second mode of operation that does not include tracking the plurality of types of physical activities of the user of the computer system; during a second time period that is different from the first time period, operating in the second mode of operation that does not include tracking the plurality of types of physical activities of the user of the computer system; while operating in the second mode of operation, detecting an end of a period of time; and in response to detecting the end of the period of time, transitioning to operating in the first mode of operation that includes tracking the plurality of types of physical activities of the user of the computer system.

In accordance with some embodiments, a computer system is described. The computer system is configured to communicate with one or more activity sensors and one or more one or more input devices and comprises: one or more processors; and memory storing one or more programs configured to be executed by the one or more processors, the one or more programs including instructions for: during a first time period, operating in a first mode of operation that includes tracking a plurality of types of physical activities, including tracking a first type of activity and tracking a second type of activity, of a user of the computer system, including: detecting, via the one or more activity sensors, first activity data corresponding to physical activities of the user of the computer system while the computer system is operating in the first mode of operation; and updating, based on the first activity data, activity metrics for the plurality of types of physical activities, including updating a first activity metric and updating a second activity metric; while operating in the first mode of operation, receiving, via one or more input devices, one or more user inputs corresponding to a request to transition to a second mode of operation, different from the first mode of operation; in response to receiving the one or more user inputs corresponding to the request to transition to the second mode of operation, transitioning to operating in the second mode of operation that does not include tracking the plurality of types of physical activities of the user of the computer system; during a second time period that is different from the first time period, operating in the second mode of operation that does not include tracking the plurality of types of physical activities of the user of the computer system; while operating in the second mode of operation, detecting an end of a period of time; and in response to detecting the end of the period of time, transitioning to operating in the first mode of operation that includes tracking the plurality of types of physical activities of the user of the computer system.

In accordance with some embodiments, a computer system is described. The computer system is configured to communicate with one or more activity sensors and one or more one or more input devices and comprises: means, during a first time period, for operating in a first mode of operation that includes tracking a plurality of types of physical activities, including tracking a first type of activity and tracking a second type of activity, of a user of the computer system, including: detecting, via the one or more activity sensors, first activity data corresponding to physical activities of the user of the computer system while the computer system is operating in the first mode of operation; and updating, based on the first activity data, activity metrics for the plurality of types of physical activities, including updating a first activity metric and updating a second activity metric; means, while operating in the first mode of operation, for receiving, via one or more input devices, one or more user inputs corresponding to a request to transition to a second mode of operation, different from the first mode of operation; in response to receiving the one or more user inputs corresponding to the request to transition to the second mode of operation, means for transitioning to operating in the second mode of operation that does not include tracking the plurality of types of physical activities of the user of the computer system; means, during a second time period that is different from the first time period, for operating in the second mode of operation that does not include tracking the plurality of types of physical activities of the user of the computer system; means, while operating in the second mode of operation, for detecting an end of a period of time; and means, responsive to detecting the end of the period of time, for transitioning to operating in the first mode of operation that includes tracking the plurality of types of physical activities of the user of the computer system.

In accordance with some embodiments, a computer program product is described. The computer program product comprises one or more programs configured to be executed by one or more processors of a computer system that is in communication with one or more activity sensors and one or more one or more input devices, the one or more programs including instructions for: during a first time period, operating in a first mode of operation that includes tracking a plurality of types of physical activities, including tracking a first type of activity and tracking a second type of activity, of a user of the computer system, including: detecting, via the one or more activity sensors, first activity data corresponding to physical activities of the user of the computer system while the computer system is operating in the first mode of operation; and updating, based on the first activity data, activity metrics for the plurality of types of physical activities, including updating a first activity metric and updating a second activity metric; while operating in the first mode of operation, receiving, via one or more input devices, one or more user inputs corresponding to a request to transition to a second mode of operation, different from the first mode of operation; in response to receiving the one or more user inputs corresponding to the request to transition to the second mode of operation, transitioning to operating in the second mode of operation that does not include tracking the plurality of types of physical activities of the user of the computer system; during a second time period that is different from the first time period, operating in the second mode of operation that does not include tracking the plurality of types of physical activities of the user of the computer system; while operating in the second mode of operation, detecting an end of a period of time; and in response to detecting the end of the period of time, transitioning to operating in the first mode of operation that includes tracking the plurality of types of physical activities of the user of the computer system.

In accordance with some embodiments, a method is described. The method comprises: at a computer system that is in communication with one or more display generation components and one or more one or more input devices: receiving, via the one or more input devices, a request to display an activity schedule user interface for a first activity metric; in response to receiving the request to display the activity schedule user interface for the first activity metric, displaying, via the one or more display generation components, the activity schedule user interface for the first activity metric, including concurrently displaying: a first activity goal for the first activity metric for a first day; a first object for modifying the first activity goal for the first activity metric for the first day; a second activity goal for the first activity metric for a second day that is different from the first day; and a second object for modifying the second activity goal for the first activity metric for the second day; while displaying the activity schedule user interface for the first activity metric, receiving, via the one or more input devices, a first input; and in response to receiving the first input: in accordance with a determination that the first input is directed to the first object, modifying the first activity goal for the first activity metric for the first day without modifying the second activity goal for the first activity metric for the second day; and in accordance with a determination that the first input is directed to the second object, modifying the second activity goal for the first activity metric for the second day without modifying the first activity goal for the first activity metric for the first day.

In accordance with some embodiments, non-transitory computer-readable storage medium is described. The non-transitory computer-readable storage medium stores one or more programs configured to be executed by one or more processors of a computer system that is in communication with one or more display generation components and one or more one or more input devices, the one or more programs including instructions for: receiving, via the one or more input devices, a request to display an activity schedule user interface for a first activity metric; in response to receiving the request to display the activity schedule user interface for the first activity metric, displaying, via the one or more display generation components, the activity schedule user interface for the first activity metric, including concurrently displaying: a first activity goal for the first activity metric for a first day; a first object for modifying the first activity goal for the first activity metric for the first day; a second activity goal for the first activity metric for a second day that is different from the first day; and a second object for modifying the second activity goal for the first activity metric for the second day; while displaying the activity schedule user interface for the first activity metric, receiving, via the one or more input devices, a first input; and in response to receiving the first input: in accordance with a determination that the first input is directed to the first object, modifying the first activity goal for the first activity metric for the first day without modifying the second activity goal for the first activity metric for the second day; and in accordance with a determination that the first input is directed to the second object, modifying the second activity goal for the first activity metric for the second day without modifying the first activity goal for the first activity metric for the first day.

In accordance with some embodiments, transitory computer-readable storage medium is described. The transitory computer-readable storage medium stores one or more programs configured to be executed by one or more processors of a computer system that is in communication with one or more display generation components and one or more one or more input devices, the one or more programs including instructions for: receiving, via the one or more input devices, a request to display an activity schedule user interface for a first activity metric; in response to receiving the request to display the activity schedule user interface for the first activity metric, displaying, via the one or more display generation components, the activity schedule user interface for the first activity metric, including concurrently displaying: a first activity goal for the first activity metric for a first day; a first object for modifying the first activity goal for the first activity metric for the first day; a second activity goal for the first activity metric for a second day that is different from the first day; and a second object for modifying the second activity goal for the first activity metric for the second day; while displaying the activity schedule user interface for the first activity metric, receiving, via the one or more input devices, a first input; and in response to receiving the first input: in accordance with a determination that the first input is directed to the first object, modifying the first activity goal for the first activity metric for the first day without modifying the second activity goal for the first activity metric for the second day; and in accordance with a determination that the first input is directed to the second object, modifying the second activity goal for the first activity metric for the second day without modifying the first activity goal for the first activity metric for the first day.

In accordance with some embodiments, a computer system is described. The computer system is configured to communicate with one or more display generation components and one or more one or more input devices and comprises: one or more processors; and memory storing one or more programs configured to be executed by the one or more processors, the one or more programs including instructions for: receiving, via the one or more input devices, a request to display an activity schedule user interface for a first activity metric; in response to receiving the request to display the activity schedule user interface for the first activity metric, displaying, via the one or more display generation components, the activity schedule user interface for the first activity metric, including concurrently displaying: a first activity goal for the first activity metric for a first day; a first object for modifying the first activity goal for the first activity metric for the first day; a second activity goal for the first activity metric for a second day that is different from the first day; and a second object for modifying the second activity goal for the first activity metric for the second day; while displaying the activity schedule user interface for the first activity metric, receiving, via the one or more input devices, a first input; and in response to receiving the first input: in accordance with a determination that the first input is directed to the first object, modifying the first activity goal for the first activity metric for the first day without modifying the second activity goal for the first activity metric for the second day; and in accordance with a determination that the first input is directed to the second object, modifying the second activity goal for the first activity metric for the second day without modifying the first activity goal for the first activity metric for the first day.

In accordance with some embodiments, a computer system is described. The computer system is configured to communicate with one or more display generation components and one or more one or more input devices and comprises: means for receiving, via the one or more input devices, a request to display an activity schedule user interface for a first activity metric; means, responsive to receiving the request to display the activity schedule user interface for the first activity metric, for displaying, via the one or more display generation components, the activity schedule user interface for the first activity metric, including concurrently displaying: a first activity goal for the first activity metric for a first day; a first object for modifying the first activity goal for the first activity metric for the first day; a second activity goal for the first activity metric for a second day that is different from the first day; and a second object for modifying the second activity goal for the first activity metric for the second day; means, while displaying the activity schedule user interface for the first activity metric, for receiving, via the one or more input devices, a first input; and means, responsive to receiving the first input, for: in accordance with a determination that the first input is directed to the first object, modifying the first activity goal for the first activity metric for the first day without modifying the second activity goal for the first activity metric for the second day; and in accordance with a determination that the first input is directed to the second object, modifying the second activity goal for the first activity metric for the second day without modifying the first activity goal for the first activity metric for the first day.

In accordance with some embodiments, a computer program product is described. The computer program product comprises one or more programs configured to be executed by one or more processors of a computer system that is in communication with one or more display generation components and one or more one or more input devices, the one or more programs including instructions for: receiving, via the one or more input devices, a request to display an activity schedule user interface for a first activity metric; in response to receiving the request to display the activity schedule user interface for the first activity metric, displaying, via the one or more display generation components, the activity schedule user interface for the first activity metric, including concurrently displaying: a first activity goal for the first activity metric for a first day; a first object for modifying the first activity goal for the first activity metric for the first day; a second activity goal for the first activity metric for a second day that is different from the first day; and a second object for modifying the second activity goal for the first activity metric for the second day; while displaying the activity schedule user interface for the first activity metric, receiving, via the one or more input devices, a first input; and in response to receiving the first input: in accordance with a determination that the first input is directed to the first object, modifying the first activity goal for the first activity metric for the first day without modifying the second activity goal for the first activity metric for the second day; and in accordance with a determination that the first input is directed to the second object, modifying the second activity goal for the first activity metric for the second day without modifying the first activity goal for the first activity metric for the first day.

In accordance with some embodiments, a method is described. The method comprises: at a computer system that is in communication with one or more display generation components and one or more one or more input devices: displaying, via the one or more display generation components, a plurality of objects in a first mode, wherein the plurality of objects includes: a first object corresponding to a first activity and including a first set of information about the first activity, and a second object, different from the first object, corresponding to a second activity and including a second set of information about the second activity; while displaying the plurality of objects in the first mode and while the first object includes the first set of information about the first activity, receiving, via the one or more input devices, an input directed to the first object; in response to receiving the input directed to the first object, initiating a process to modify the first object without initiating a process to modify the second object; during the process to modify the first object, receiving, via the one or more input devices, one or more inputs to modify the first object, including one or more inputs to modify the first set of information about the first activity to a third set of information about the first activity that is different from the first set of information about the first activity; and subsequent to the process to modify the first object, displaying, via the one or more display generation components, the plurality of objects, including the first object with the third set of information about the first activity.

In accordance with some embodiments, a non-transitory computer-readable storage medium is described. The non-transitory computer-readable storage medium stores one or more programs configured to be executed by one or more processors of a computer system that is in communication with one or more display generation components and one or more one or more input devices, the one or more programs including instructions for: displaying, via the one or more display generation components, a plurality of objects in a first mode, wherein the plurality of objects includes: a first object corresponding to a first activity and including a first set of information about the first activity, and a second object, different from the first object, corresponding to a second activity and including a second set of information about the second activity; while displaying the plurality of objects in the first mode and while the first object includes the first set of information about the first activity, receiving, via the one or more input devices, an input directed to the first object; in response to receiving the input directed to the first object, initiating a process to modify the first object without initiating a process to modify the second object; during the process to modify the first object, receiving, via the one or more input devices, one or more inputs to modify the first object, including one or more inputs to modify the first set of information about the first activity to a third set of information about the first activity that is different from the first set of information about the first activity; and subsequent to the process to modify the first object, displaying, via the one or more display generation components, the plurality of objects, including the first object with the third set of information about the first activity.

In accordance with some embodiments, a transitory computer-readable storage medium is described. The transitory computer-readable storage medium stores one or more programs configured to be executed by one or more processors of a computer system that is in communication with one or more display generation components and one or more one or more input devices, the one or more programs including instructions for: displaying, via the one or more display generation components, a plurality of objects in a first mode, wherein the plurality of objects includes: a first object corresponding to a first activity and including a first set of information about the first activity, and a second object, different from the first object, corresponding to a second activity and including a second set of information about the second activity; while displaying the plurality of objects in the first mode and while the first object includes the first set of information about the first activity, receiving, via the one or more input devices, an input directed to the first object; in response to receiving the input directed to the first object, initiating a process to modify the first object without initiating a process to modify the second object; during the process to modify the first object, receiving, via the one or more input devices, one or more inputs to modify the first object, including one or more inputs to modify the first set of information about the first activity to a third set of information about the first activity that is different from the first set of information about the first activity; and subsequent to the process to modify the first object, displaying, via the one or more display generation components, the plurality of objects, including the first object with the third set of information about the first activity.

In accordance with some embodiments, a computer system is described. The computer system is configured to communicate with one or more display generation components and one or more one or more input devices and comprises: one or more processors; and memory storing one or more programs configured to be executed by the one or more processors, the one or more programs including instructions for: displaying, via the one or more display generation components, a plurality of objects in a first mode, wherein the plurality of objects includes: a first object corresponding to a first activity and including a first set of information about the first activity, and a second object, different from the first object, corresponding to a second activity and including a second set of information about the second activity; while displaying the plurality of objects in the first mode and while the first object includes the first set of information about the first activity, receiving, via the one or more input devices, an input directed to the first object; in response to receiving the input directed to the first object, initiating a process to modify the first object without initiating a process to modify the second object; during the process to modify the first object, receiving, via the one or more input devices, one or more inputs to modify the first object, including one or more inputs to modify the first set of information about the first activity to a third set of information about the first activity that is different from the first set of information about the first activity; and subsequent to the process to modify the first object, displaying, via the one or more display generation components, the plurality of objects, including the first object with the third set of information about the first activity.

In accordance with some embodiments, a computer system is described. The computer system is configured to communicate with one or more display generation components and one or more one or more input devices and comprises: means for displaying, via the one or more display generation components, a plurality of objects in a first mode, wherein the plurality of objects includes: a first object corresponding to a first activity and including a first set of information about the first activity, and a second object, different from the first object, corresponding to a second activity and including a second set of information about the second activity; means, while displaying the plurality of objects in the first mode and while the first object includes the first set of information about the first activity, for receiving, via the one or more input devices, an input directed to the first object; means, responsive to receiving the input directed to the first object, for initiating a process to modify the first object without initiating a process to modify the second object; means, during the process to modify the first object, for receiving, via the one or more input devices, one or more inputs to modify the first object, including one or more inputs to modify the first set of information about the first activity to a third set of information about the first activity that is different from the first set of information about the first activity; and means, subsequent to the process to modify the first object, for displaying, via the one or more display generation components, the plurality of objects, including the first object with the third set of information about the first activity.

In accordance with some embodiments, a computer program product is described. The computer program product comprises one or more programs configured to be executed by one or more processors of a computer system that is in communication with one or more display generation components and one or more one or more input devices, the one or more programs including instructions for: displaying, via the one or more display generation components, a plurality of objects in a first mode, wherein the plurality of objects includes: a first object corresponding to a first activity and including a first set of information about the first activity, and a second object, different from the first object, corresponding to a second activity and including a second set of information about the second activity; while displaying the plurality of objects in the first mode and while the first object includes the first set of information about the first activity, receiving, via the one or more input devices, an input directed to the first object; in response to receiving the input directed to the first object, initiating a process to modify the first object without initiating a process to modify the second object; during the process to modify the first object, receiving, via the one or more input devices, one or more inputs to modify the first object, including one or more inputs to modify the first set of information about the first activity to a third set of information about the first activity that is different from the first set of information about the first activity; and subsequent to the process to modify the first object, displaying, via the one or more display generation components, the plurality of objects, including the first object with the third set of information about the first activity.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing physical activity user interfaces, thereby increasing the effectiveness, efficiency, and user satisfaction with such devices. Such methods and interfaces may complement or replace other methods for managing physical activity user interfaces.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AO illustrate exemplary user interfaces for managing physical activity user interfaces, in accordance with some embodiments.

FIG. 7 is a flow diagram illustrating methods of managing activity tracking, in accordance with some embodiments.

FIG. 8 is a flow diagram illustrating methods of managing activity goals, in accordance with some embodiments.

FIG. 9 is a flow diagram illustrating methods of managing activity user interfaces, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing physical activity user interfaces. Such techniques can reduce the cognitive burden on a user who accesses user interfaces for physical activities, thereby enhancing productivity. Further, such techniques can reduce processor and battery power otherwise wasted on redundant user inputs.

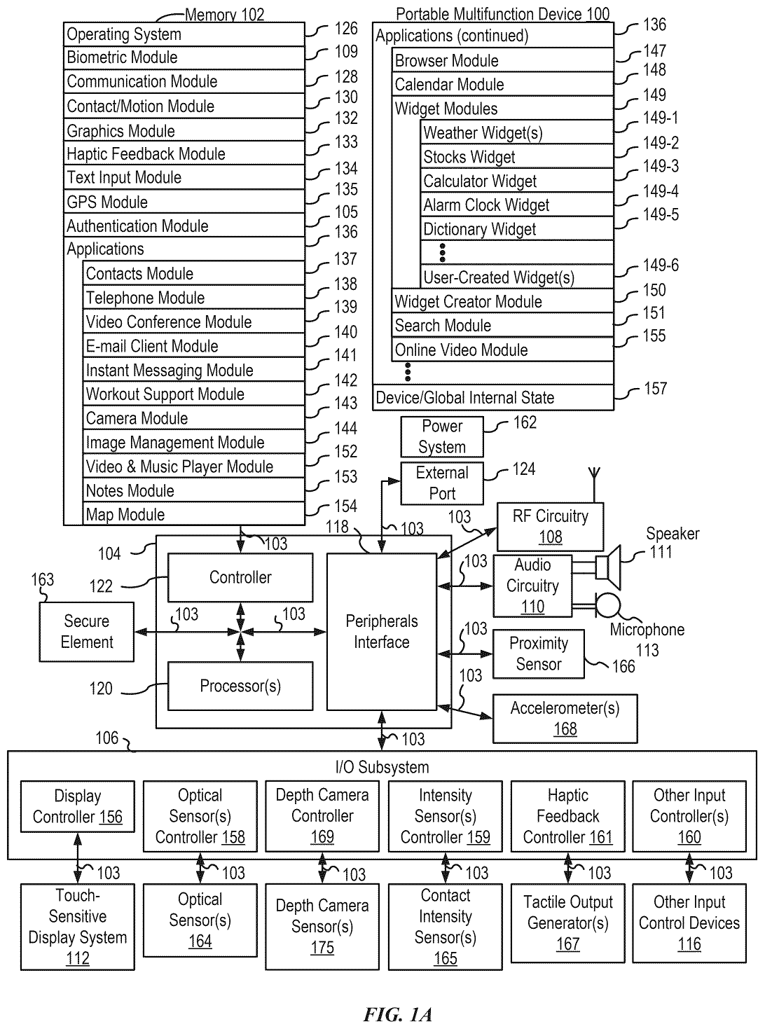

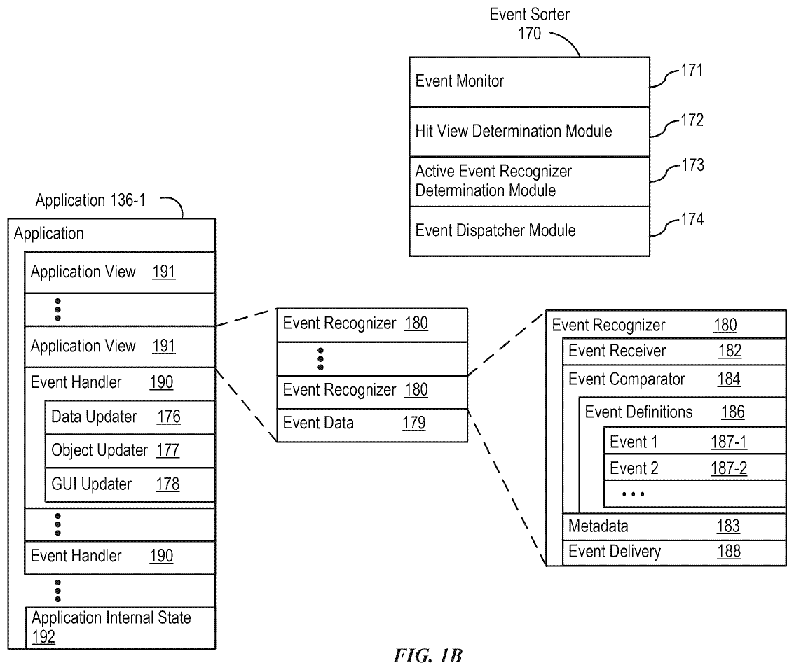

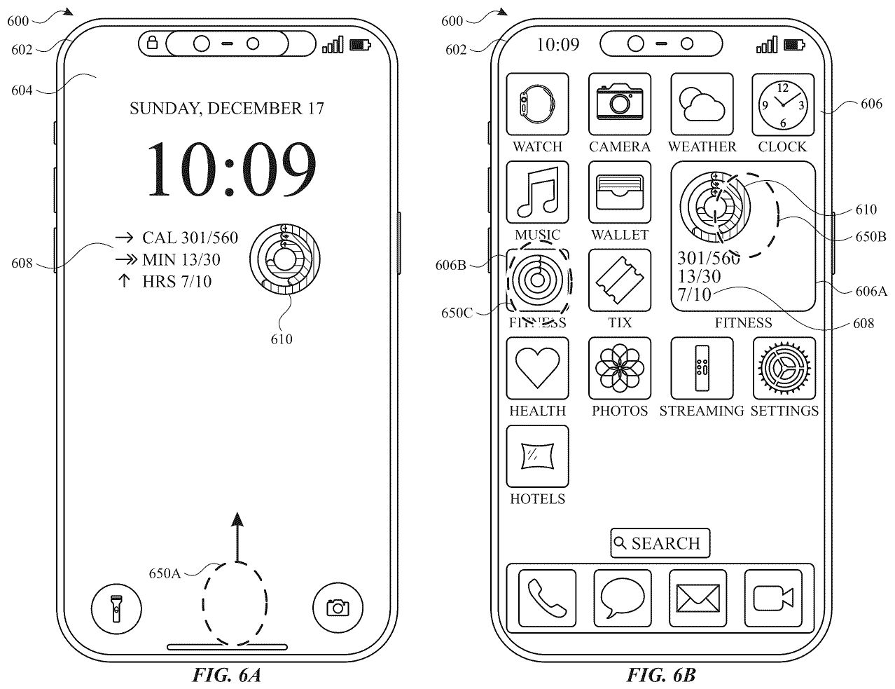

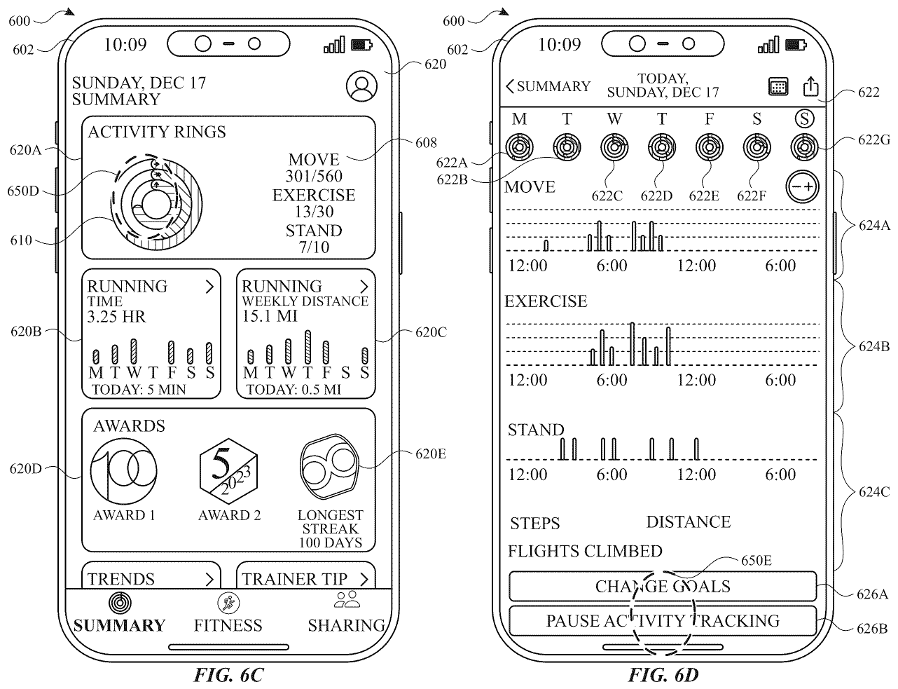

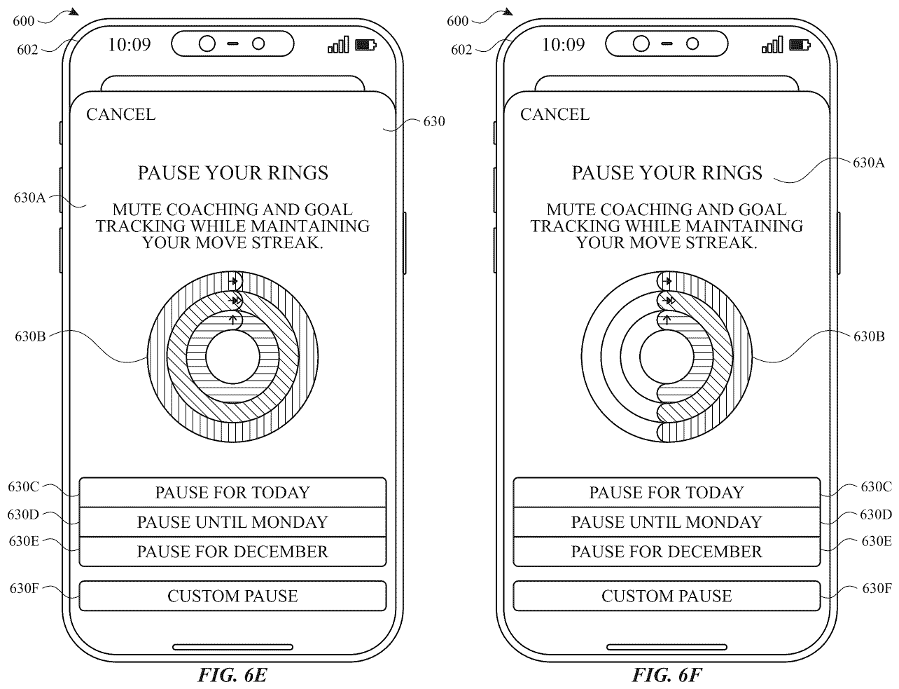

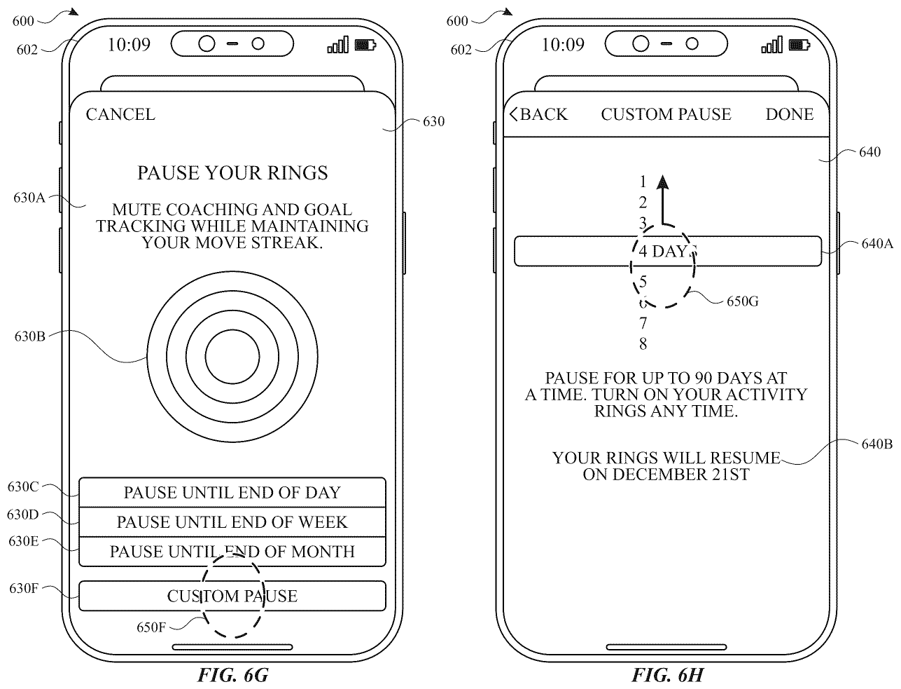

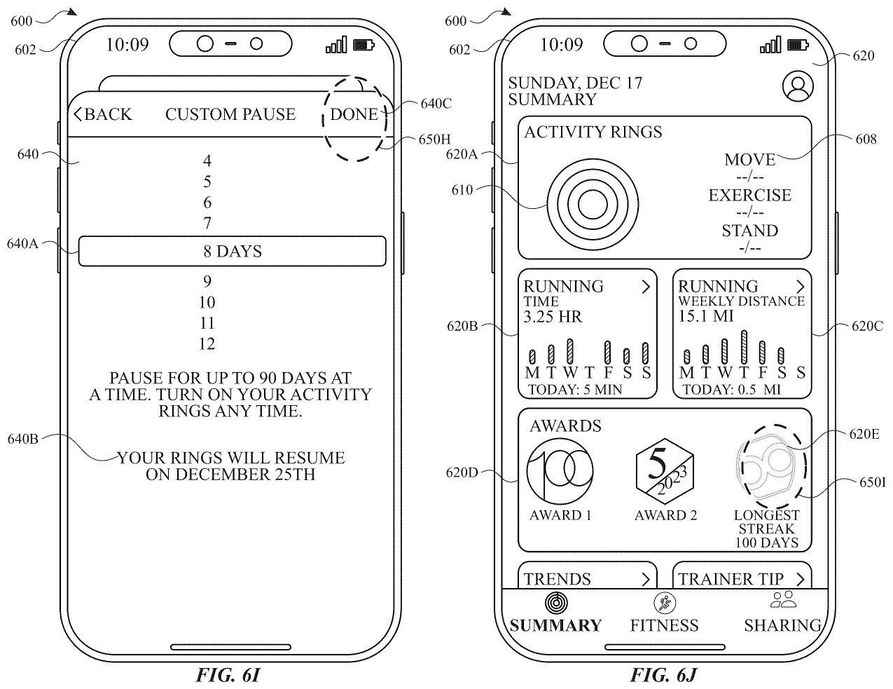

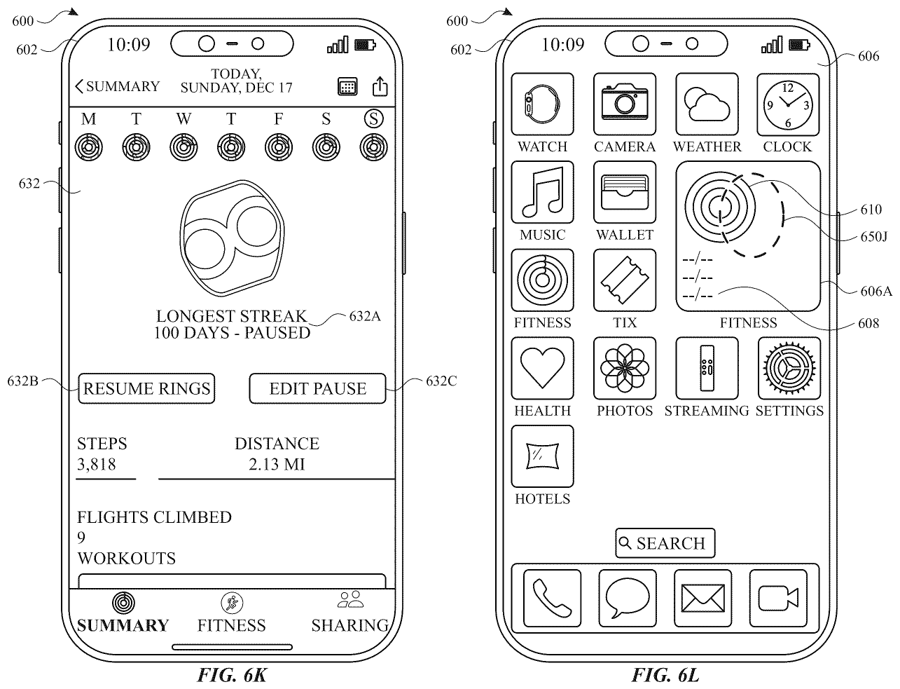

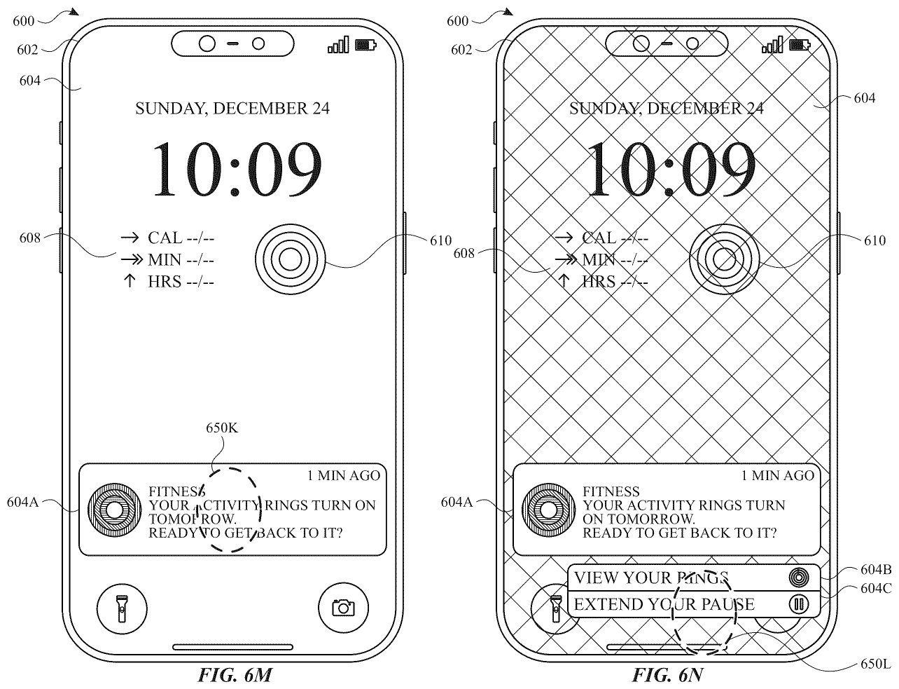

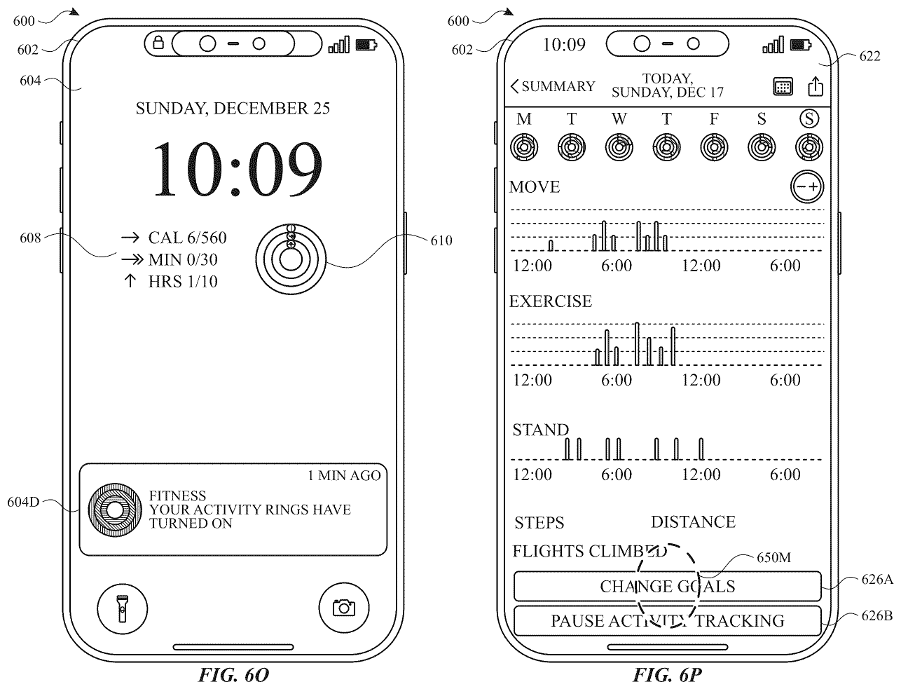

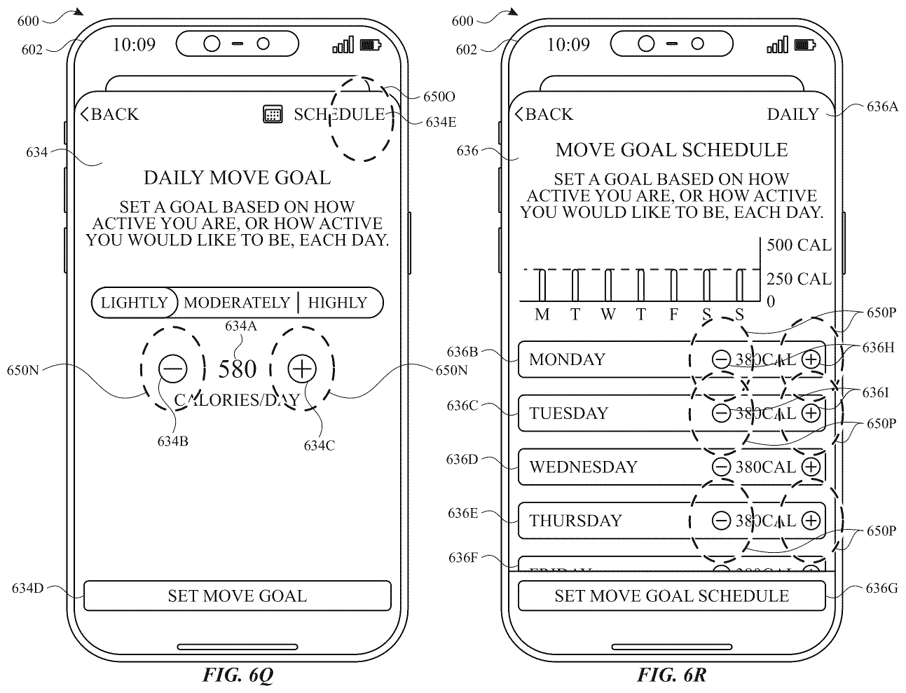

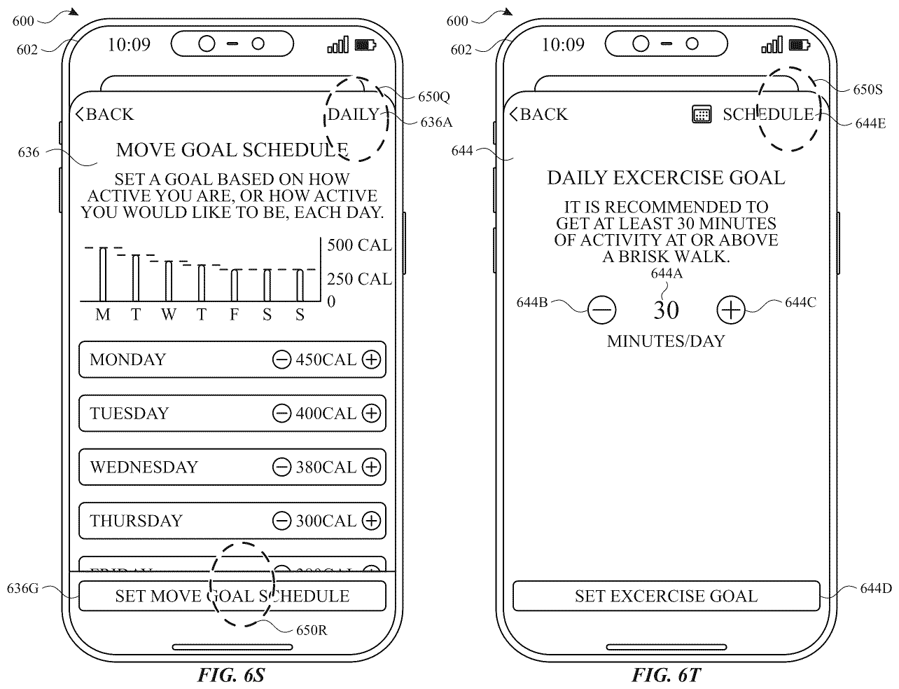

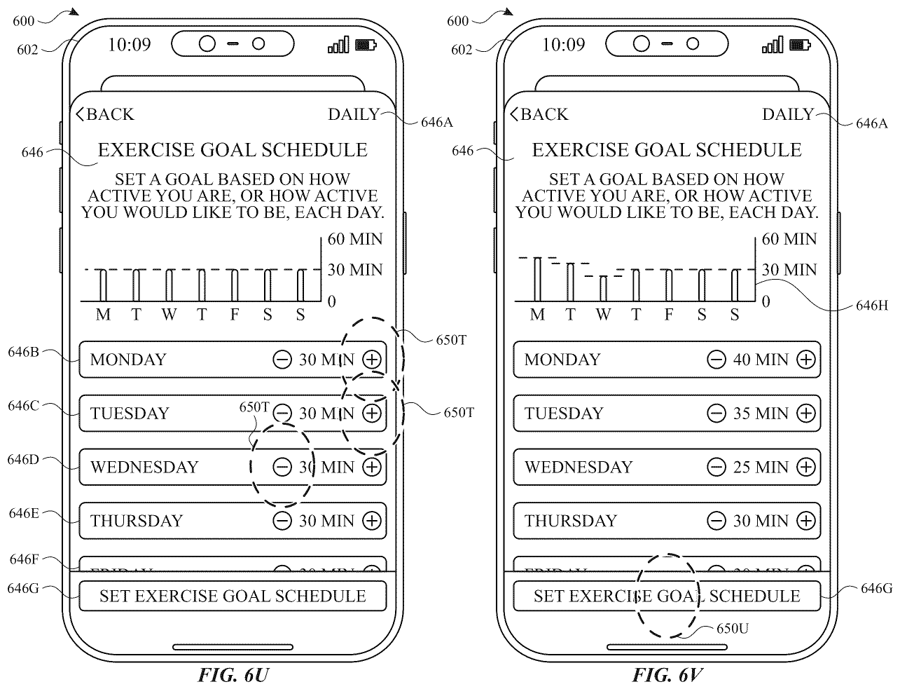

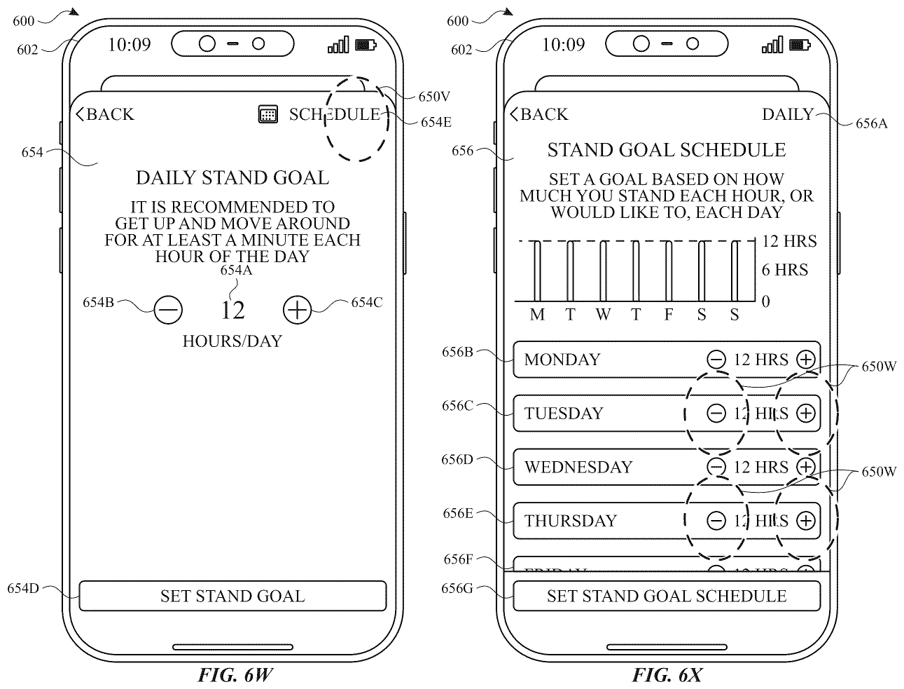

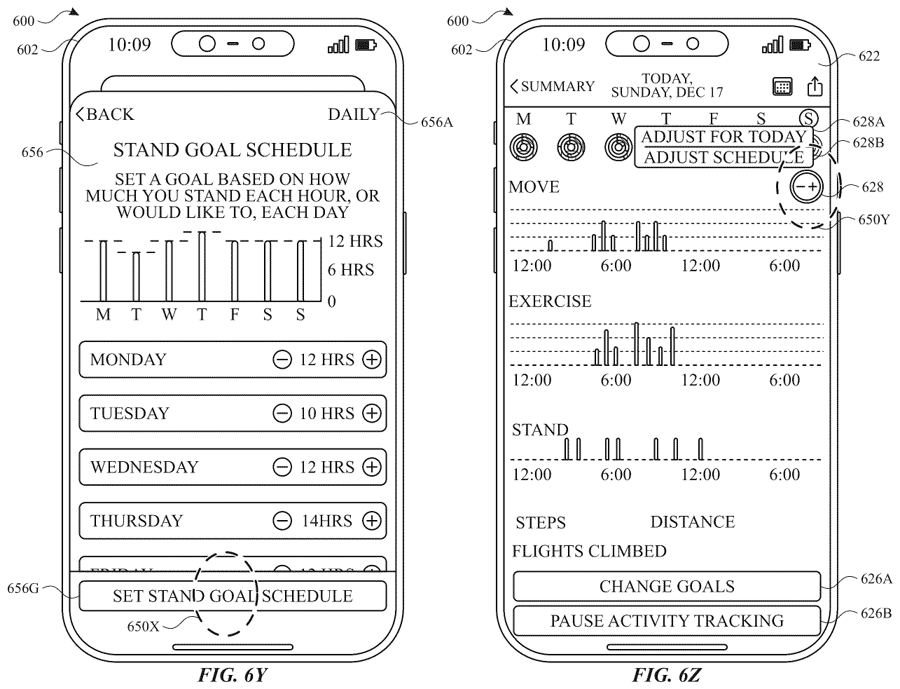

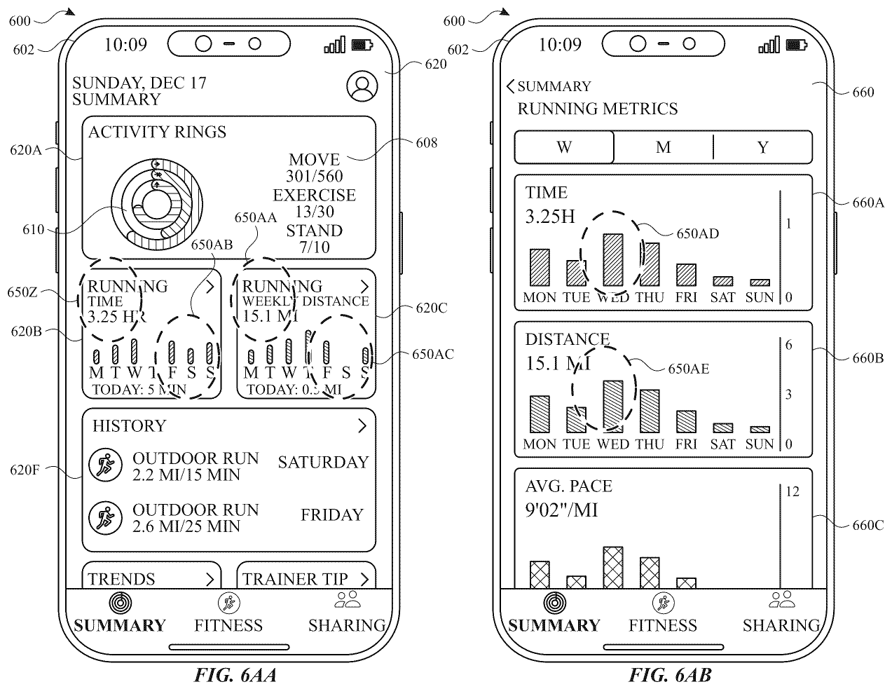

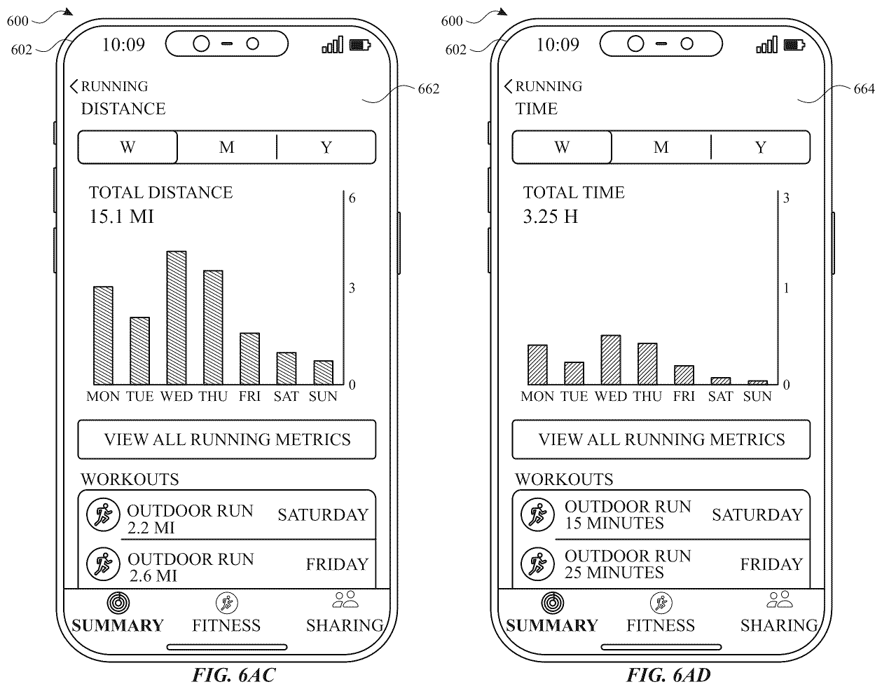

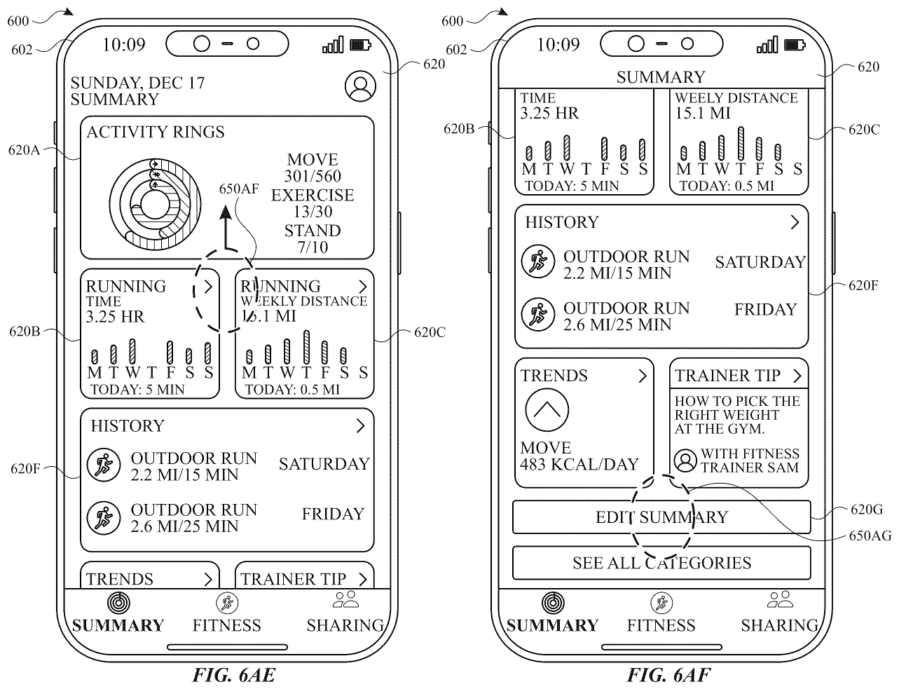

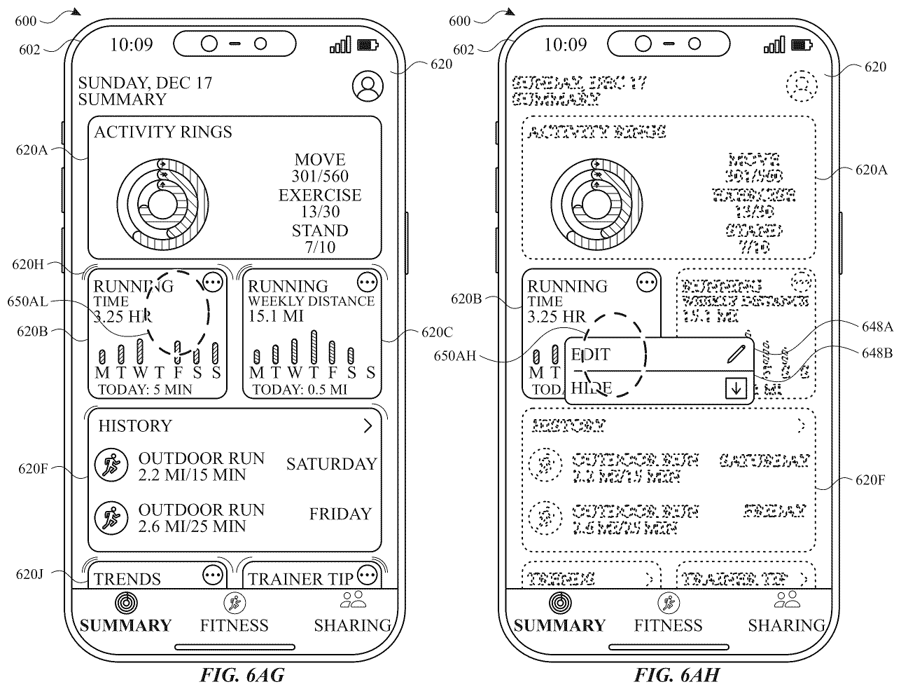

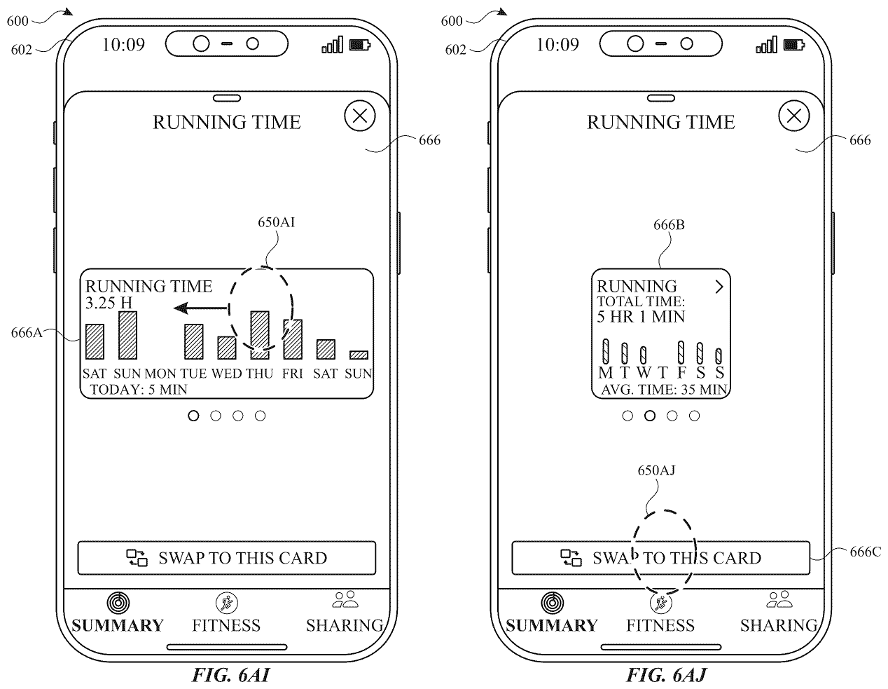

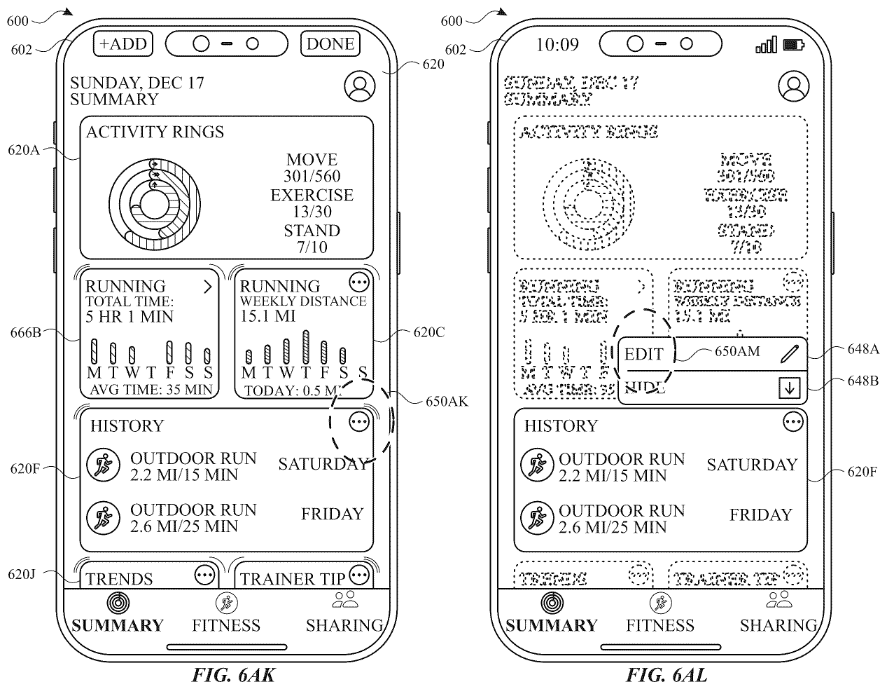

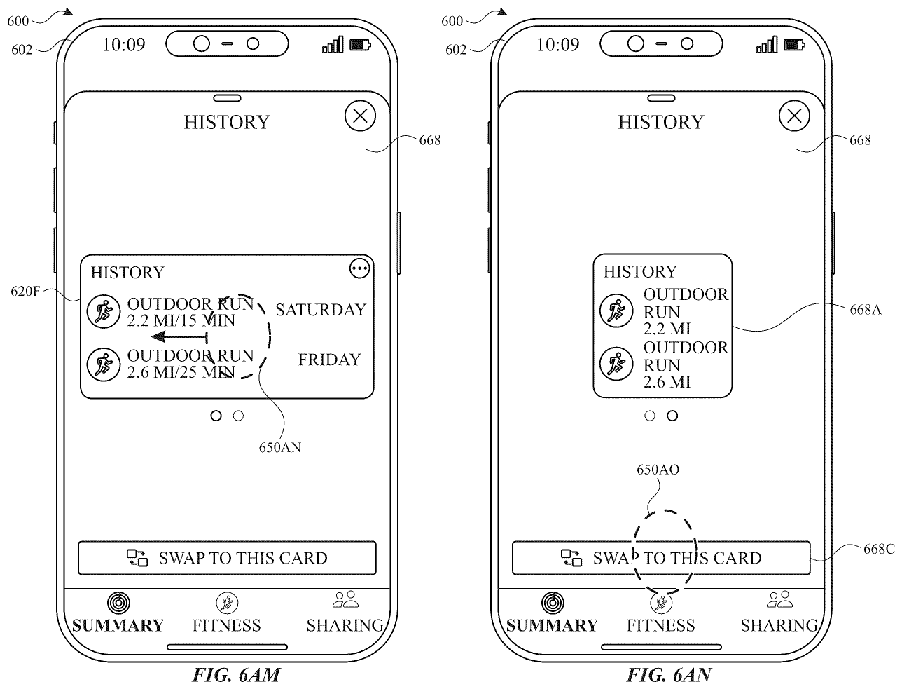

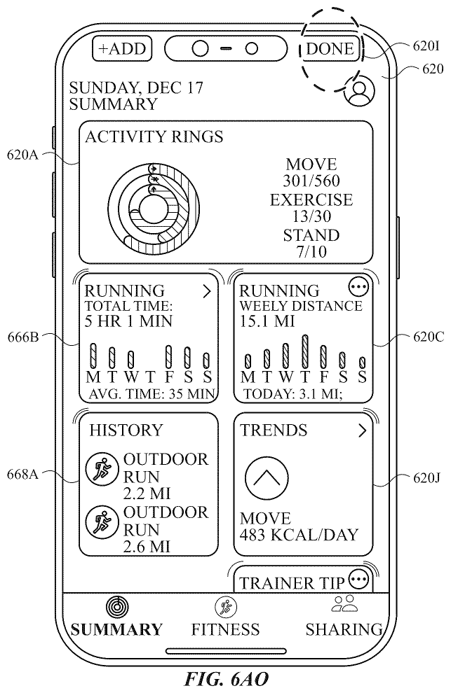

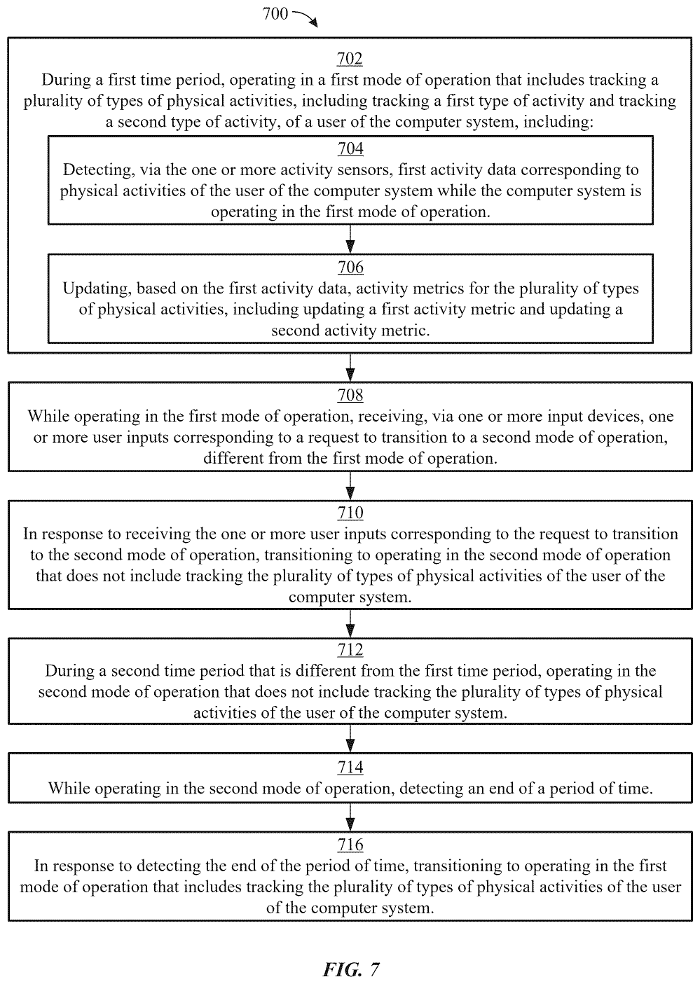

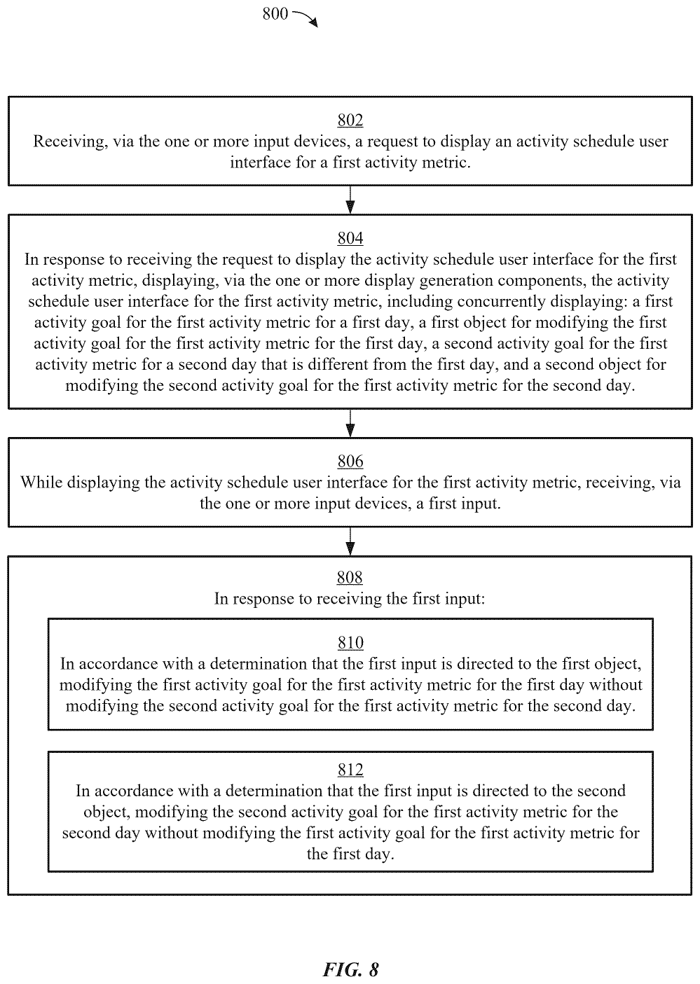

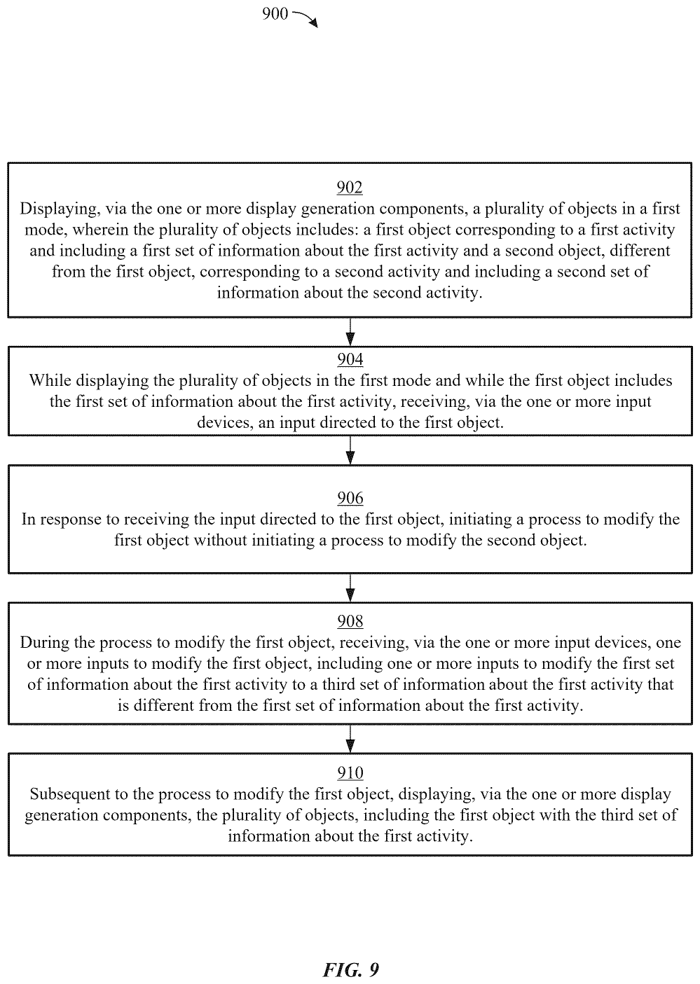

Below, FIGS. 1A-1B, 2, 3A-3G, 4A-4B, and 5A-5B provide a description of exemplary devices for performing the techniques for managing physical activity user interfaces. FIGS. 6A-6AO illustrate exemplary user interfaces for managing physical activity user interfaces. FIG. 7 is a flow diagram illustrating methods of managing activity tracking, in accordance with some embodiments. FIG. 8 is a flow diagram illustrating methods of managing activity goals, in accordance with some embodiments. FIG. 9 is a flow diagram illustrating methods of managing activity user interfaces, in accordance with some embodiments. The user interfaces in FIGS. 6A-6AO are used to illustrate the processes described below, including the processes in FIGS. 7-9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

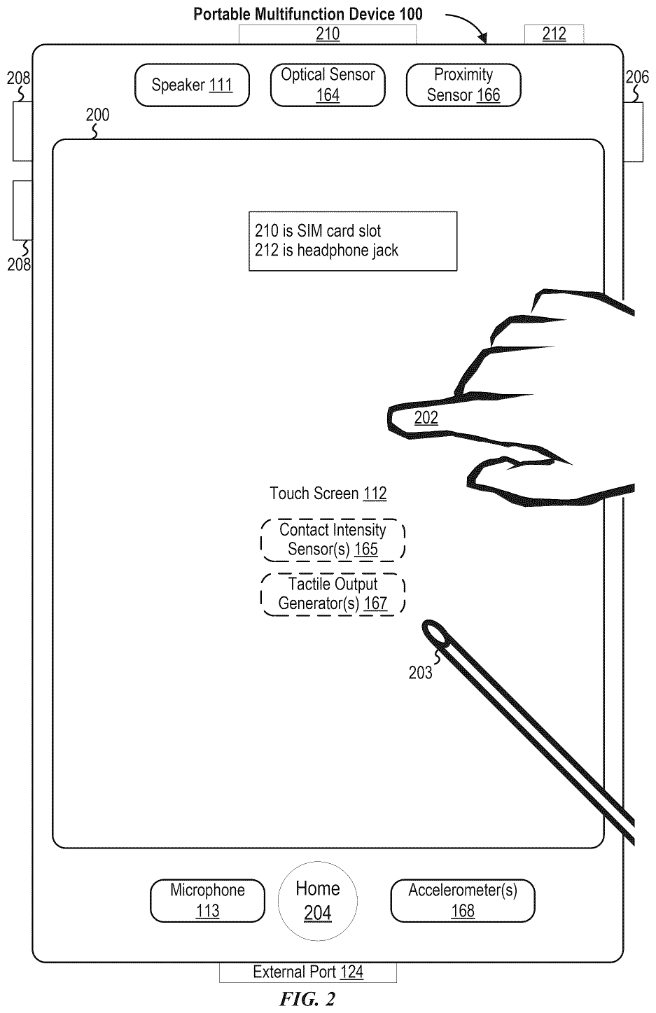

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

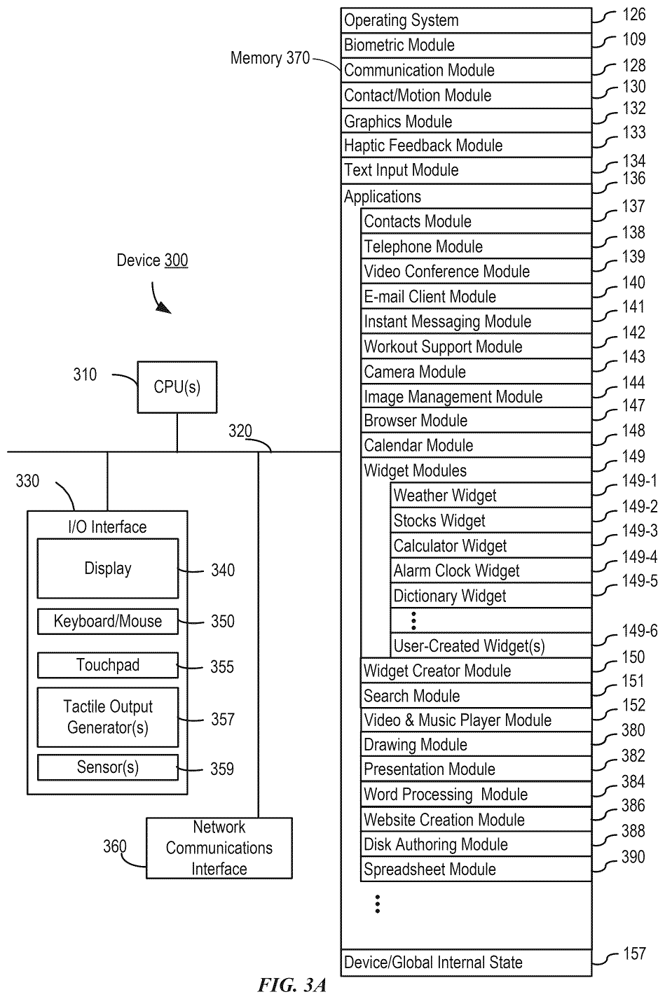

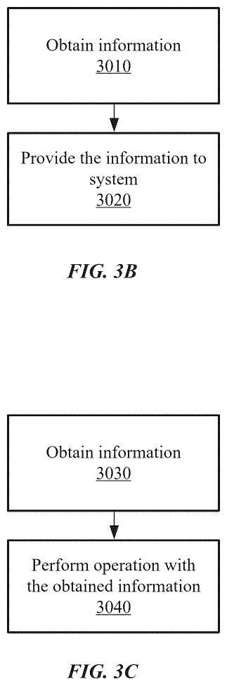

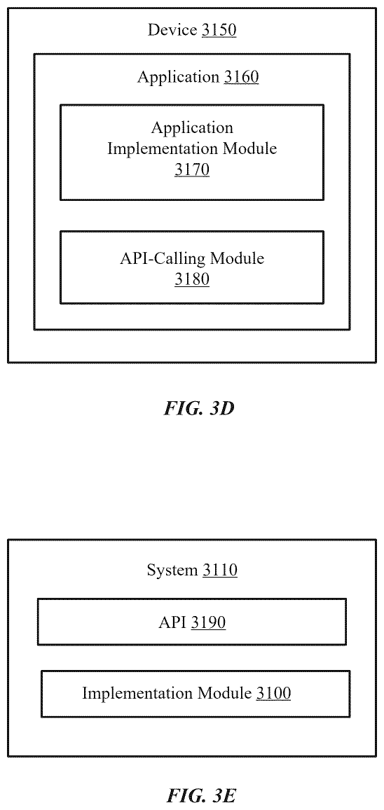

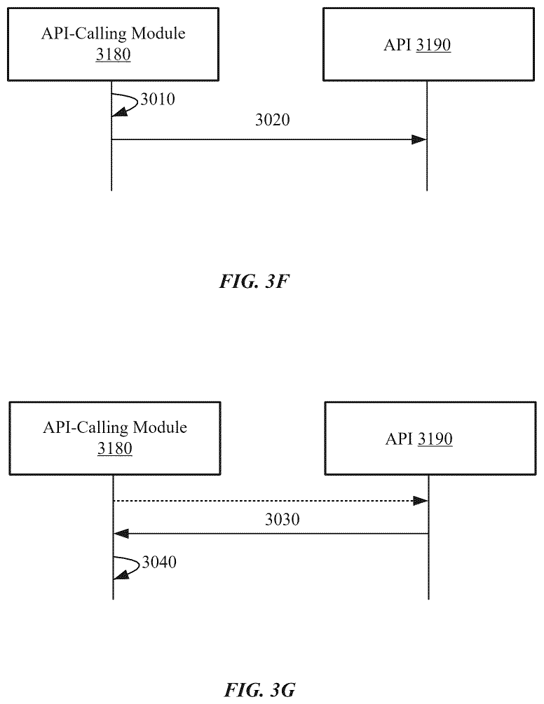

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 800, and/or 900 (FIGS. 7, 8, and/or 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

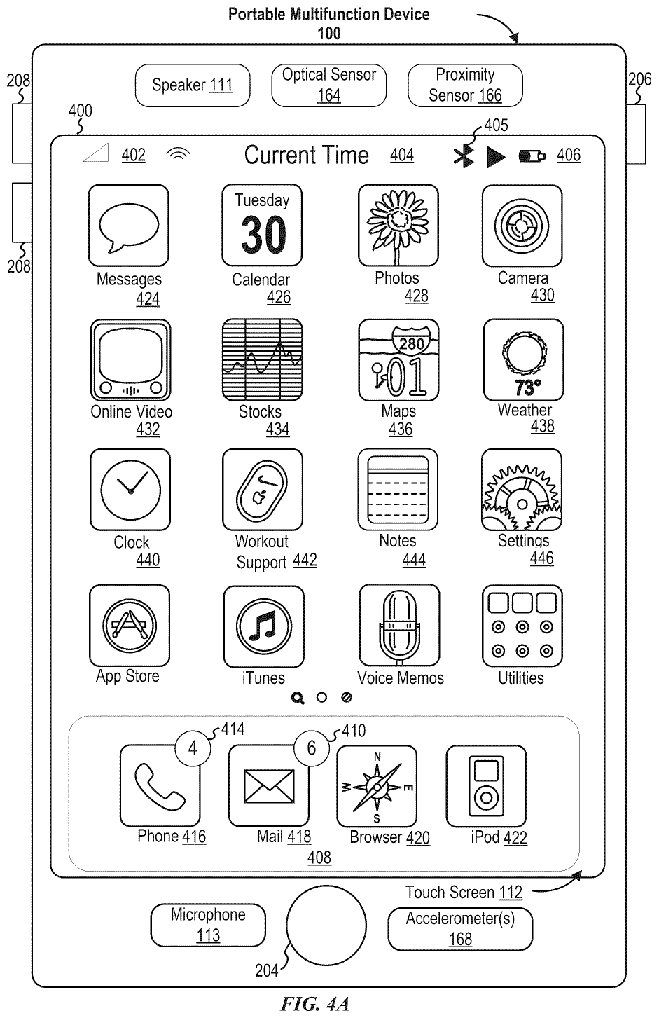

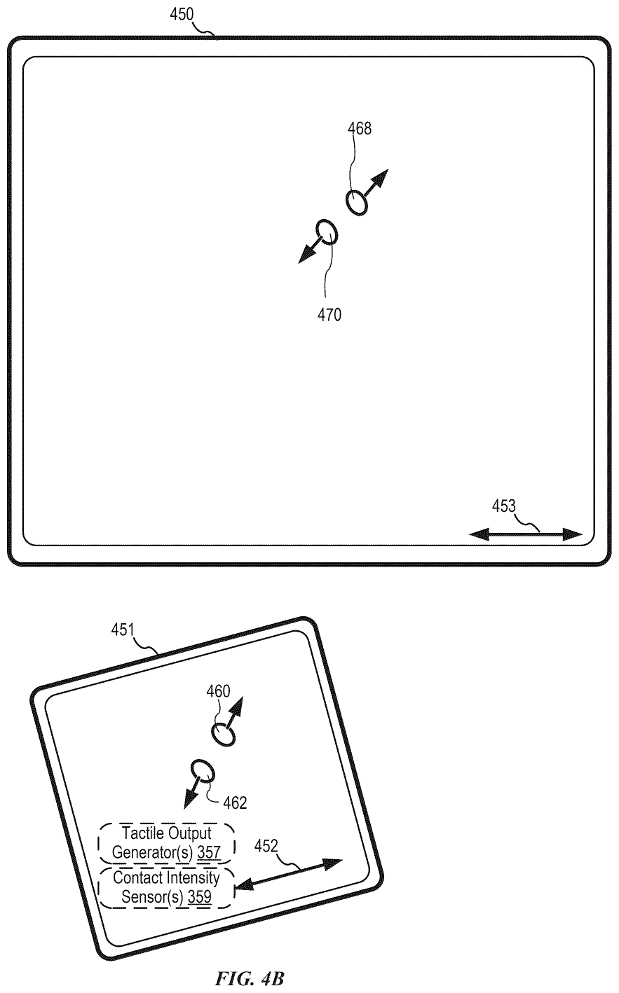

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

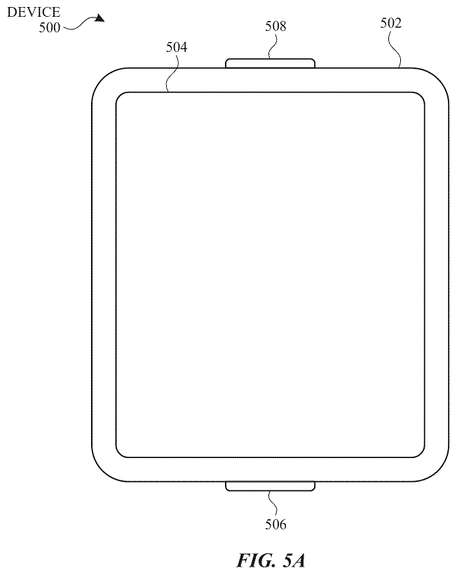

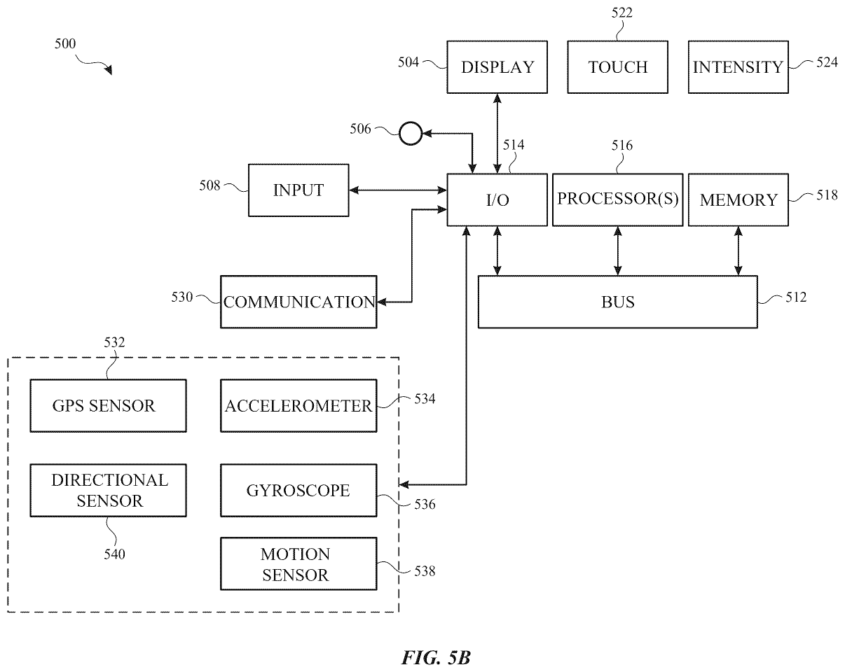

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700-900 (FIGS. 7-9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6AO illustrate exemplary user interfaces for managing physical activity user interfaces, in accordance with some embodiments. The user interfaces in these figures are used to illustrate the processes described below, including the processes in FIGS. 7-9.

FIG. 6A illustrates computer system 600 with display 602. In some embodiments, display 602 is a touchscreen display that includes a touch-sensitive surface for detecting touch inputs. Computer system 600 is in communication with one or more activity sensors that detect a user's physical activity. In some embodiments, computer system 600 is in communication with an external device (e.g., a smart watch worn by the user) that includes the one or more activity sensors. In some embodiments, the one or more activity sensors are integrated into computer system 600. In some embodiments, the one or more activity sensors include one or more of: an optical heart sensor, an electrical heart sensor, an accelerometer, gyroscope, and/or a location sensor (e.g., GPS sensor). Thus, computer system 600 is configured to detect physical activity being performed by a user of the device. In some embodiments, the detected physical activity is characterized by activity data (e.g., data transmitted, stored, and/or accessed that represents the detected physical activity).

At FIG. 6A, computer system 600 is displaying, via display 602, lock screen user interface 604, which includes two activity progress indictors: textual activity progress indicator 608 and graphical activity progress indicator 610. As shown in FIG. 6A, computer system 600 provides the user with visual feedback about the user's progress towards achieving activity goals for three different activity metrics. For example, computer system 600 tracks the user's movements throughout the day and encourages the user to make progress towards the activity goals by showing the user the progress the user has made thus far. In some embodiments, the three different activity metrics are: how often the user stands, how much the user moves, and how many minutes of exercise the user performs. Textual activity progress indicator 608 provides a textual summary of the goals and the user's progress toward the goal for each of the three different activity metrics. Graphical activity progress indicator 610 provides a graphical summary of the user's progress toward the goal for each of the three different activity metrics via three rings, with each activity metric represented by a ring of a different color. The activity progress indicators encourage the user to sit less, to move more, and to get exercise. In some embodiments, the activity goals are daily goals and the progress towards achieving the activity goals is reset each day (e.g., at midnight and/or at 3:00 am).

At FIG. 6A, the three different activity metrics are active calories burned, minutes of exercise, and stand hours. As indicated by textual activity progress indicator 608 on lock screen user interface 604, computer system 600 has detected that the user has burned 301 calories out of a goal of 560 calories for the day, has exercised for 13 minutes out of a goal of 30 minutes of exercise for the day, and has stood for at least threshold amount of time (e.g., 1 minute and/or 5 minutes) during each of 7 hours of the day out of a goal of 10 stand hours. Graphical activity progress indicator 610 reflects the same progress towards achieving the three different activity goals for the different activity metrics. Accordingly, one full loop around the outside ring represents the goal of burning 560 active calories (e.g., the active calories burned goal), one full loop around the center ring represents the goal of exercising for 30 minutes (e.g., the minutes of exercise goal), and one full loop around the interior ring represents the goal of having stood (and, optionally, moved) for at least the threshold amount of time (e.g., 1 minute and/or 5 minutes) per hour (e.g., the stand hours goals). Graphical activity progress indicator 610 indicates the progress towards the user achieving the activity goals for each of the three activity metrics by filling in the respective ring based on the amount of progress for the respective activity metric. Various activities can progress the activity metrics. For example, running optionally progresses each of the three activity metrics because the user is burning active calories, is exercising, and is in an upright (e.g., standing) position. For another example, swimming optionally progresses two of the activity metrics because the user is burning active calories and is exercising, but is not standing.

At FIG. 6A, computer system 600 is receiving activity data and is updating (e.g., as additional activity data is received, on regular intervals, and/or in response to particular system events) the activity progress indictors (e.g., 608 and 610). In other words, activity progress tracking is not paused. Because activity progress tracking is not paused, the activity progress indicators (e.g., 608 and 610) indicate the user's progress towards achieving the activity goals. Further, because activity progress tracking is not paused, when computer system 600 determines that the user has performed activities that progress a respective activity metric (e.g., towards or past the respective activity goal), computer system 600 updates textual activity progress indicator 608 and graphical activity progress indicator 610 to reflect the progress. At FIG. 6A, computer system 600 receives input 650A (e.g., a swipe input, a touch input, an air gesture, a mouse click, a gaze input, and/or a speech input) to dismiss lock screen user interface 604.

At FIG. 6B, in response to receiving input 650A, computer system 600 displays home screen user interface 606. Home screen user interface 606 includes objects (e.g., icons and widgets) that, when activated, display a user interface that corresponds to the activated object. For example, home screen user interface 606 includes an icon for a music application, an icon for a photos application, icon 606B for a fitness application, and activity progress widget 606A for displaying activity progress indicators. At FIG. 6B, because activity progress tracking is not paused, the activity progress indicators (e.g., 608 and 610) of activity progress widget 606A indicate the user's progress towards achieving the activity goals and update as computer system 600 detects (e.g., via the one or more activity sensors) further progress. At FIG. 6B, computer system 600 receives input 650B (e.g., a tap input, a touch input, an air gesture, a mouse click, a gaze input, and/or a speech input) directed to activity progress widget 606A and/or receives input 650C (e.g., a tap input, a touch input, an air gesture, a mouse click, a gaze input, and/or a speech input) directed to icon 606B.

At FIG. 6C, in response to receiving input 650B and/or 650C, computer system 600 displays fitness summary user interface 620. Fitness summary user interface 620 includes various objects (e.g., cards and/or widgets), such as activity progress object 620A, time object 620B, distance object 620C, and awards object 620D. In some embodiments, the various objects (e.g., 620A-620D) are in an arrangement (e.g., in an ordered arrangement). In some embodiments, the various objects update over time to reflect updated data, statistics, and/or metrics. Activity progress object 620A includes textual activity progress indicator 608 and graphical activity progress indicator 610. Because activity progress tracking is not paused, the activity progress indicators (e.g., 608 and 610) indicate the user's progress towards achieving the activity goals. Time object 620B includes time statistics for the running activity, including a total time run during the past week (e.g., 3.25 hours), the total time run today (e.g., 5 minutes), and a graphical indication (e.g., a bar graph) of the amount of time run for each day of the past week. Distance object 620C includes distance statistics for the running activity, including a total distance run during the past week (e.g., 15.1 miles), total distance run today (e.g., 0.5 miles), and a graphical indication (e.g., a bar graph) of the distance run for each day of the past week. As shown in FIG. 6C, time object 620B and distance object 620C correspond to the same activity—running. In some embodiments, different objects correspond to different metrics (e.g., time, distance, elevation change, calories burned, and/or laps) for different activities (e.g., running, walking, swimming, hiking, and/or swimming). Thus, in some embodiments, time object 620B and distance object 620C correspond to the same (e.g., time and time, or distance and distance) or different (e.g., time and distance, or time and laps) metrics for different activities (e.g., running and swimming, or hiking and walking). Awards object 620D includes rewards earned (e.g., recently earned or recently updated) for performing activities. For example, award 1 is an award for reaching 100 active calorie goals for 100 (e.g., consecutive or non-consecutive) days. Streak award 620E is an award that indicates the longest streak (e.g., in days) that the user has achieved an activity goal (e.g., has met respective activity goals on respective days). For example, streak award 620E indicates that the use has met the active calorie goal for 100 (e.g., consecutive) days—a streak that is still active (e.g., since there have been no intervening days during which the user has not met a respective active calorie goal for the day). At FIG. 6C, computer system 600 receives input 650D (e.g., a tap input, a touch input, an air gesture, a mouse click, a gaze input, and/or a speech input) directed to activity progress object 620A.

At FIG. 6D, in response to receiving input 650D, computer system 600 displays activity progress details user interface 622. Activity progress details user interface 622 includes a plurality of graphical activity progress indicators 622A-622G corresponding to the most recent 7 days (e.g., including the current day). Each of activity progress indicators 622A-622G indicate the user's progress towards achieving activity goals for the three different activity metrics (same activity metrics as 608 and 610) for respective prior days. Move graph 624A provides a detailed view (e.g., hourly view) of active calories burned (e.g., for the current day) and corresponds to the active calories burned metric of activity progress indictors 608 and 610 (e.g., outside ring of 610). Exercise graph 624B provides a detailed view (e.g., hourly view) of minutes of exercise performed (e.g., for the current day) and corresponds to the minutes of exercise metric of activity progress indictors 608 and 610 (e.g., center ring of 610). Stand graph 624C provides a detailed view (e.g., hourly view) of stand hours (e.g., for the current day) and corresponds to the stand hours metric of activity progress indictors 608 and 610 (e.g., interior ring of 610). Activity progress details user interface 622 also includes change goals option 626A and pause activity tracking option 626B. At FIG. 6D, computer system 600 receives input 650E (e.g., a tap input, a touch input, an air gesture, a mouse click, a gaze input, and/or a speech input) directed to pause activity tracking option 626B.

At FIG. 6E, in response to receiving input 650E, computer system 600 displays pause user interface 630. Pause user interface 630 includes textual description 630A about what it means to pause activity tracking, representation 630B of a graphical activity progress indicator that has reached all goals (e.g., is filled in for all three rings, independent of the user's progress towards achieving the activity goals for today or any other day), and duration options 630C-630F. While displaying pause user interface 630 and without receiving further user input, computer system 600 displays (as shown in FIGS. 6E-6G) an animation of representation 630B of the graphical activity progress indicator reducing (e.g., synchronized, concurrently, and/or sequentially) (e.g., at FIG. 6F) the indications of progress (e.g., by reducing the how much each ring is filled over time) to no progress (e.g., at FIG. 6G) and then optionally graying out representation 630B of a graphical activity progress indicator. This animation indicates to the user that pausing activity progress tracking (e.g., via buttons 630C-630F) will stop updating the activity progress indicators (e.g., 608 and/or 610) (and, optionally, revert them to indicate no progress). As shown in FIG. 6G, activation of duration option 630C initiates a process for pausing activity progress tracking for the current day (e.g., including earlier times of the current day and later days of the current day), activation of duration option 630D initiates a process for pausing activity progress tracking for the current week (e.g., including earlier days of the current week, the current day, and future days of the current week), activation of duration option 630E initiates a process for pausing activity progress tracking for the current month (e.g., including earlier days of the current month, the current day, and future days of the current month), and activation of duration option 630F initiates a process for pausing activity progress tracking for a user-configured number of days. At FIG. 6G, computer system 600 receives input 650F (e.g., a tap input, a touch input, an air gesture, a mouse click, a gaze input, and/or a speech input) directed to duration option 630F.

At FIG. 6H, in response to receiving input 650F, computer system 600 displays pause duration user interface 640. Pause duration user interface 640 includes duration selector 640A for selecting a pause duration (e.g., in hours, in days, and/or in months) and date indicator 640B, which indicates the date on which activity progress tracking will resume based on the selected pause duration. At FIG. 6H, computer system 600 receives input 650G (e.g., a drag input, a swipe input, a touch input, an air gesture, a mouse click, a gaze input, and/or a speech input) directed to duration selector 640A.

At FIG. 6I, in response to receiving input 650G, computer system 600 updates display of duration selector 640A to indicate that activity progress tracking will be paused for 8 days if the user proceeds with pausing. Computer system 600 also updates (e.g., in response to receiving input 650G) date indicator 640B to indicate that activity progress tracking will resume on December 25th if the users proceeds, as shown in FIG. 6I. At FIG. 6I, computer system 600 receives input 650H (e.g., a tap input, a touch input, an air gesture, a mouse click, a gaze input, and/or a speech input) directed to done option 640C.

At FIG. 6J, in response to receiving input 650H, computer system 600 pauses activity progress tracking. At FIG. 6J, computer system 600 is optionally receiving activity data via the one or more activity sensors and is updating some activity metrics (e.g., such as 620B and 620C), but computer system 600 is not updating activity progress indictors (e.g., 608 and 610) based on the received activity data (because activity progress tracking is paused). At FIG. 6J, because activity progress tracking is paused, computer system 600 displays the activity progress indicators (e.g., 608 and 610) without indicating any progress towards achieving activity goals (e.g., textual activity progress indicator 608 has dashes for the progress and/or the goals and graphical activity progress indicator 610 is grayed out). In some embodiments, streaks that were active (e.g., since there had been no intervening days during which the user had not met a respective goal for the day) are also paused when activity progress tracking is paused. In some embodiments, streaks that are based on the number of days (e.g., consecutive and/or sequential) that a user meets a respective activity goal are paused when activity progress tracking is paused for the same activity metric, as discussed in greater detail with respect to FIG. 6K. In some embodiments, at FIG. 6J, streak award 620E is updated to indicate that the streak tracking is paused (e.g., by including “paused” and/or included a graphical indication). At FIG. 6J, computer system 600 receives input 650I (e.g., a tap input, a touch input, an air gesture, a mouse click, a gaze input, and/or a speech input) directed to

At FIG. 6K, in response to receiving input 650I, computer system 600 displays streak user interface 632. Streak user interface 632 includes indication 632A that activity progress tracking is paused and, therefore, the streak tracking is paused. Accordingly, once activity progress tracking is resumed (e.g., unpaused), computer system 600 will continue to monitor the user's progress achieving activity goals for the activity metric corresponding to the streak. As a result, pausing activity progress tracking enables the computer system to resume the streak once activity progress tracking resumes. At FIG. 6K, streak user interface 632 also includes resume option 632B and edit pause option 632C. Resume option 632B, when activated, initiates a process to resume activity progress tracking and streak tracking (e.g., resumes activity progress tracking and streak tracking). Edit pause option 632C, when activated, initiates a process to change the duration for which activity progress tracking (and therefore streak tracking) is paused. For example, computer system 600 displays pause duration user interface 640 in response to receiving input directed to edit pause option 632C.

At FIG. 6L, computer system 600 is displaying home screen user interface 606. At FIG. 6L, because activity progress tracking is paused, computer system 600 displays the activity progress indicators (e.g., 608 and 610) without indicating any progress towards achieving activity goals (e.g., textual activity progress indicator 608 has dashes for the progress and/or the goals and graphical activity progress indicator 610 is grayed out). At FIG. 6L, computer system 600 receives input 650J (e.g., a tap input, a touch input, an air gesture, a mouse click, a gaze input, and/or a speech input) directed to activity progress widget 606A. In response to receiving input 650J, computer system 600 displays fitness summary user interface 620 with activity progress indicators (e.g., 608 and 610, displayed as part of 620A) without indicating any progress towards achieving activity goals (e.g., textual activity progress indicator 608 has dashes for the progress and/or the goals and graphical activity progress indicator 610 is grayed out).

At FIG. 6M, computer system 600 is displaying lock screen user interface 604 while activity progress tracking is paused. Because activity progress tracking is paused, the activity progress indicators (e.g., 608 and 610) do not indicate any progress towards achieving activity goals (e.g., textual activity progress indicator 608 has dashes for the progress and/or the goals and graphical activity progress indicator 610 is grayed out). At FIG. 6M, in accordance with a determination that activity progress tracking will be enabled (e.g., unpaused) the next day, computer system 600 displays notification 604A indicating that activity progress tracking will be enabled the next day. Computer system 600 receives input 650K (e.g., a long touch input, a tap input, a touch input, an air gesture, a mouse click, a gaze input, and/or a speech input) directed to notification 604A.

At FIG. 6N, in response to receiving input 650K, computer system 600 displays options 604B and 604C. In some embodiments, in response to receiving activation of option 604B, computer system 600 displays fitness summary user interface 620 or activity progress details user interface 622. At FIG. 6N, computer system 600 receives input 650L (e.g., a tap input, a touch input, an air gesture, a mouse click, a gaze input, and/or a speech input) directed to option 604C and, in response, computer system 600 initiates a process to change the duration for which activity progress tracking is paused. For example, computer system 600 displays pause duration user interface 640 in response to receiving input directed to option 604C.

At FIG. 6O, in accordance with a determination that the pause duration (e.g., configured at FIGS. 6I-6J) has ended (e.g., after the 8 days has passed), computer system 600 displays notification 604D on lock screen user interface 604 to indicate that activity progress tracking has resumed (e.g., is now unpaused). At FIG. 6O, because activity progress tracking is not paused, the activity progress indicators (e.g., 608 and 610) indicate the user's progress towards achieving the activity goals.

At FIG. 6P, computer system 600 displays activity progress details user interface 622, as described in detail with respect to FIG. 6D. At FIG. 6P, computer system receives input 650M (e.g., a long touch input, a tap input, a touch input, an air gesture, a mouse click, a gaze input, and/or a speech input) directed to change goals option 626A.

At FIG. 6Q, in response to receiving input 650M, computer system 600 initiates a process to enable the user to configure different goals for the different activity metrics indicated as part of the activity progress indicators. At FIG. 6Q, in response to receiving input 650M, computer system 600 displays daily move goals user interface 634. Daily move goals user interface 634 enables computer system 600 to receive user inputs (e.g., 650N directed to 634B and/or 634C) to change the active calories burned goal (e.g., as indicated by 634A) that applies to every day of the week (e.g., computer system 600 uses the same active calories burned goal, such as 580 calories/day, for every Monday, Tuesday, Wednesday, Thursday, Friday, Saturday, and Sunday). In some embodiments, computer system 600 receives input 650O (e.g., a tap input, a touch input, an air gesture, a mouse click, a gaze input, and/or a speech input) directed to schedule option 634E.

At FIG. 6R, in response to receiving input 650O, computer system 600 displays move schedule user interface 636. Move schedule user interface 636 enables computer system 600 to receive user inputs (e.g., 650P) to change the active calories burned goal (e.g., as indicated in each respective day 636B-636F) for individual days of the week (e.g., computer system 600 optionally uses different active calories burned goals for every Monday, Tuesday, Wednesday, Thursday, Friday, Saturday, and Sunday). For example, as shown in FIG. 6S, the active calories burned goals are set to: 450 calories for Mondays, 400 calories for Tuesdays, 380 calories for Wednesdays, 300 calories for Thursdays, etc. Thus, computer system 600 receives user inputs to configure different active calories burned goals for different days of the week to accommodate the user's active lifestyle (e.g., lower goal on Thursdays as a recovery day), thereby providing the user with additional abilities to customize the user's fitness planning. For example, the different active calories burned goals for different days of the week are reflected in graph 636H. In some embodiments, as illustrated in FIG. 6S, in response to receiving input 650Q (e.g., a tap input, a touch input, an air gesture, a mouse click, a gaze input, and/or a speech input) directed to daily option 636A, computer system 600 returns to daily move goals user interface 634 without configuring the different goals. At FIG. 6S, computer system 600 receives input 650R (e.g., a tap input, a touch input, an air gesture, a mouse click, a gaze input, and/or a speech input) directed to continue option 636G.

At FIG. 6S, in response to receiving input 650R, computer system 600 sets the different active calories burned goals (as specified by the user) for the different days of the week (e.g., that were reflected in move schedule user interface 636) and displays daily exercise goals user interface 644. Daily exercise goals user interface 644 enables computer system 600 to receive user inputs (e.g., directed to 644B and/or 644C) to change the minutes of exercise goal (e.g., as indicated by 644A) that applies to every day of the week (e.g., computer system 600 uses the same minutes of exercise goal, such as 30 minutes/day, for every Monday, Tuesday, Wednesday, Thursday, Friday, Saturday, and Sunday). In some embodiments, computer system 600 receives input 650S (e.g., a tap input, a touch input, an air gesture, a mouse click, a gaze input, and/or a speech input) directed to schedule option 644E.

At FIG. 6T, in response to receiving input 650S, computer system 600 displays exercise schedule user interface 646. Exercise schedule user interface 646 enables computer system 600 to receive user inputs (e.g., 650T) to change the minutes of exercise goal (e.g., as indicated in each respective day 646B-646F) for individual days of the week (e.g., computer system 600 optionally uses different minutes of exercise goals for every Monday, Tuesday, Wednesday, Thursday, Friday, Saturday, and Sunday). For example, as shown in FIG. 6U, the minutes of exercise goals are set to: 40 minutes for Mondays, 35 minutes for Tuesdays, 25 minutes for Wednesdays, 30 minutes for Thursdays, etc. Thus, computer system 600 receives user inputs to configure different minutes of exercise goals for different days of the week to accommodate the user's active lifestyle (e.g., lower goal on Wednesdays and Thursdays as recovery days), thereby providing the user with additional abilities to customize the user's fitness planning. For example, the different minutes of exercise goals for different days of the week are reflected in graph 646H. In some embodiments, as illustrated in FIG. 6V, in response to receiving input (e.g., a tap input, a touch input, an air gesture, a mouse click, a gaze input, and/or a speech input) directed to daily option 646A, computer system 600 returns to daily exercise goals user interface 644 without configuring the different goals. At FIG. 6V, computer system 600 receives input 650U (e.g., a tap input, a touch input, an air gesture, a mouse click, a gaze input, and/or a speech input) directed to continue option 646G.

At FIG. 6W, in response to receiving input 650U, computer system 600 sets the different minutes of exercise goals (as specified by the user) for the different days of the week (e.g., that were reflected in exercise schedule user interface 646) and displays daily stand goals user interface 654. Daily stand goals user interface 654 enables computer system 600 to receive user inputs (e.g., directed to 654B and/or 654C) to change the stand goal (e.g., as indicated by 654A) that applies to every day of the week (e.g., computer system 600 uses the same stand goal, such as 12 hours/day, for every Monday, Tuesday, Wednesday, Thursday, Friday, Saturday, and Sunday). In some embodiments, computer system 600 receives input 650V (e.g., a tap input, a touch input, an air gesture, a mouse click, a gaze input, and/or a speech input) directed to schedule option 654E.

At FIG. 6X, in response to receiving input 650V, computer system 600 displays stand schedule user interface 656. Stand schedule user interface 656 enables computer system 600 to receive user inputs (e.g., 650W) to change the stand goal (e.g., as indicated in each respective day 656B-656F) for individual days of the week (e.g., computer system 600 optionally uses different stand goals for every Monday, Tuesday, Wednesday, Thursday, Friday, Saturday, and Sunday). For example, as shown in FIG. 6Y, the stand goals are set to: 12 hours for Mondays, 10 hours for Tuesdays, 12 hours for Wednesdays, 14 hours for Thursdays, etc. Thus, computer system 600 receives user inputs to configure different stand goals for different days of the week to accommodate the user's active lifestyle, thereby providing the user with additional abilities to customize the user's fitness planning. For example, the different stand goals for different days of the week are reflected in graph 656H. In some embodiments, as illustrated in FIG. 6Y, in response to receiving input (e.g., a tap input, a touch input, an air gesture, a mouse click, a gaze input, and/or a speech input) directed to daily option 656A, computer system 600 returns to daily stand goals user interface 654 without configuring the different goals. At FIG. 6Y, computer system 600 receives input 650X (e.g., a tap input, a touch input, an air gesture, a mouse click, a gaze input, and/or a speech input) directed to continue option 656G.

At FIG. 6Z, in response to receiving input 650X, computer system 600 sets the different minutes of exercise goals (as specified by the user) for the different days of the week (e.g., that were reflected in stand schedule user interface 656) and returns to displaying activity progress details user interface 622. At FIG. 6Z, computer system 600 has received input 650Y (e.g., a tap input, a touch input, an air gesture, a mouse click, a gaze input, and/or a speech input) directed to adjust option 628. In response to receiving input 650Y, computer system 600 displays first adjust option 628A and second adjust option 628B. In some embodiments, in response to activation of first adjust option 628A, computer system 600 initiates a process for adjusting one or multiple activity goals for the different activity metrics (e.g., active calories burned goal, minutes of exercise goal, and/or stand goal) for the current day (e.g., without adjusting goals for other days). In some embodiments, in response to activation of second adjust option 628B, computer system 600 initiates a process to adjust the schedule for one or multiple activity goals for the different activity metrics, such as by displaying the user interfaces of FIGS. 6R, 6U, and/or 6X.

At FIG. 6AA, computer system 600 is displaying fitness summary user interface 620. Because activity progress tracking is not paused, the activity progress indicators (e.g., 608 and 610) displayed as part of activity progress object 620A indicate the user's progress towards achieving the activity goals. As described above, fitness summary user interface 620 also includes time object 620B and distance object 620C. Time object 620B includes time statistics for the running activity, including a total time run during the past week (e.g., 3.25 hours), the total time run today (e.g., 5 minutes), and a graphical indication (e.g., a bar graph) of the amount of time run for each day of the past week. Distance object 620C includes distance statistics for the running activity, including a total distance run during the past week (e.g., 15.1 miles), total distance run today (e.g., 0.5 miles), and a graphical indication (e.g., a bar graph) of the distance run for each day of the past week. As shown in FIG. 6AA, time object 620B and distance object 620C correspond to the same activity-running. In some embodiments, different objects correspond to different metrics (e.g., time, distance, elevation change, calories burned, and/or laps) for different activities (e.g., running, walking, swimming, hiking, and/or swimming). Thus, in some embodiments, time object 620B and distance object 620C correspond to the same (e.g., time and time, or distance and distance) or different (e.g., time and distance, or time and laps) metrics for different activities (e.g., running and swimming, or hiking and walking).

At FIG. 6AA, computer system 600 receives an input (e.g., a tap input, a touch input, an air gesture, a mouse click, a gaze input, and/or a speech input). In response to receiving the input and in accordance with a determination that the input (e.g., 650Z and/or 650AA) is directed to a first portion (e.g., a top portion and/or a title) of time object 620B and/or distance object 620C, computer system 600 displays running details user interface 660, as shown in FIG. 6AB. In response to receiving the input and in accordance with a determination that the input (e.g., 650AB) is directed to a second portion (e.g., a bottom portion and/or a graph portion) of time object 620B, computer system 600 displays running time details user interface 664, as shown in FIG. 6AD. In response to receiving the input and in accordance with a determination that the input (e.g., 650AC) is directed to a second portion (e.g., a bottom portion and/or a graph portion) of distance object 620C, computer system 600 displays running distance details user interface 662, as shown in FIG. 6AC.

At FIG. 6AB, running details user interface 660 corresponds to the activity of the selected object (e.g., 620B and/or 620C) and includes details about that activity, such as graphs for different metrics, including time graph 660A, distance graph 660B, and average pace graph 660C. In some embodiments, the order of graphs 660A-660C is based on an order of objects 620A-620C and/or 620F in fitness summary user interface 620. For example, if computer system 600 receives user inputs to reorder (e.g., swap the order of) objects 620B and 620C in fitness summary user interface 620, the order of graphs 660A and 660B in running details user interface 660 would change accordingly (e.g., the order would get swapped).

In response to receiving input 650AD (e.g., a tap input, a touch input, an air gesture, a mouse click, a gaze input, and/or a speech input) directed to time graph 660A at FIG. 6AB, computer system 600 displays running time details user interface 664, as shown in FIG. 6AD. In response to receiving input 650AE (e.g., a tap input, a touch input, an air gesture, a mouse click, a gaze input, and/or a speech input) directed to distance graph 660B at FIG. 6AB, computer system 600 displays running distance details user interface 662, as shown in FIG. 6AC.

At FIG. 6AC, running distance details user interface 662 enables the user to access different information about the metric (e.g., distance) for the activity (e.g., running), such as by viewing weekly, monthly, or yearly graphs, and viewing recent workouts for the activity. At FIG. 6AD, running time details user interface 664 enables the user to access different information about the metric (e.g., time) for the activity (e.g., running), such as by viewing weekly, monthly, or yearly graphs, and viewing recent workouts for the activity.

At FIG. 6AE, computer system 600 is displaying fitness summary user interface 620. While displaying fitness summary user interface 620, computer system 600 receives input 650AF (e.g., a swipe input, a drag input, a touch input, an air gesture, a mouse click, a gaze input, and/or a speech input) directed to fitness summary user interface 620. At FIG. 6AF, in response to receiving input 650AF, computer system 600 scrolls fitness summary user interface 620 to display edit option 620G. At FIG. 6AF, computer system 600 receive inputs 650AG (e.g., a tap input, a touch input, an air gesture, a mouse click, a gaze input, and/or a speech input) directed to edit option 620G.

At FIG. 6AG, in response to receiving input 650AG, computer system transitions fitness summary user interface 620 into an edit mode, as indicated by objects (e.g., 620B, 620C, 620F, and 620J, but not 620A) of fitness summary user interface 620 jiggling (e.g., as represented by movement indicators 620H). While in the edit mode, objects (e.g., 620B, 620C, 620F, and 620J, but not 620A) of fitness summary user interface 620 can be reordered and/or rearranged in response to user inputs. For example, a drag input on a respective object moves the respective object in the arrangement of fitness summary user interface 620. At FIG. 6AG, as noted above, in some embodiments, computer system 600 does not permit for the location of activity progress object 620A to be changed within the arrangement, does not permit for activity progress object 620A to me deleted or hidden, and/or does not permit for activity progress object 620A to be edited. Accordingly, in some embodiments, activity progress object 620A does not jiggle while fitness summary user interface 620 is in the edit mode. At FIG. 6AG, while in the edit mode, computer system 600 receives input 650AL (e.g., a tap input, a touch input, an air gesture, a mouse click, a gaze input, and/or a speech input) directed to time object 620B.

At FIG. 6AH, in response to receiving input 650AL directed to time object 620B, computer system 600 displays edit option 648A and hide option 648B (e.g., partially or fully overlaid on fitness summary user interface 620 and/or time object 620B). Edit option 648A is for editing the selected object (e.g., time object 620B) and hide option 648B is for hiding and/or deleting the selected object (e.g., time object 620B). At FIG. 6AH, computer system 600 receives input 650AH (e.g., a tap input, a touch input, an air gesture, a mouse click, a gaze input, and/or a speech input) directed to edit option 648A.

At FIG. 6AI, in response to receiving input 650AH, computer system 600 displays time editing user interface 666, which includes first time object 666A and paging dots indicating that other time objects can be accessed via user inputs. First time object 666A includes different (e.g., more) information as compared to time object 620B. For example, first time object 666A includes 9 days of running time information. First time object 666A is also a different shape and size as compared to time object 620B. At FIG. 6AI, computer system 600 receives input 650AI (e.g., a swipe input, a touch input, an air gesture, a mouse click, a gaze input, and/or a speech input) directed to first time object 666A and, in response, displays second time object 666B at FIG. 6AJ. Second time object 666B includes different information as compared to time object 620B and as compared to first time object 666A. For example, second time object 666B includes an average running time, rather than a running time for the current day. Second time object 666B is the same size and shape as time object 620B. In some embodiments, at FIG. 6AJ, a swipe input on second time object 666B would display an additional time object for the user to select. At FIG. 6AJ, computer system 600 receives input 650AJ directed to swap option 666C.

At FIG. 6AK, in response to receiving input 650AJ, computer system 600 replaces time object 620B with second time object 666B in fitness summary user interface 620. At FIG. 6AK, while in the edit mode, computer system 600 receives input 650AK (e.g., a tap input, a touch input, an air gesture, a mouse click, a gaze input, and/or a speech input) directed to history object 620F.

At FIG. 6AL, in response to receiving input 650AK directed to history object 620F, computer system 600 displays edit option 648A and hide option 648B (e.g., partially or fully overlaid on fitness summary user interface 620 and/or history object 620F). Edit option 648A is for editing the selected object (e.g., history object 620F) and hide option 648B is for hiding and/or deleting the selected object (e.g., history object 620F). At FIG. 6AL, computer system 600 receives input 650AM (e.g., a tap input, a touch input, an air gesture, a mouse click, a gaze input, and/or a speech input) directed to edit option 648A.

At FIG. 6AM, in response to receiving input 650AM, computer system 600 displays history editing user interface 668, which includes history object 620F and paging dots indicating that other history objects can be accessed via user inputs. At FIG. 6AM, computer system 600 receives input 650AN (e.g., a swipe input, a touch input, an air gesture, a mouse click, a gaze input, and/or a speech input) directed to history object 620F and, in response, displays second history object 668A at FIG. 6AN. Second history object 668A includes different (e.g., less) information as compared to history object 620F. For example, second history object 668A does not include time information for the activities (e.g., walks). Second history object 668A is a different size and shape as history object 620F. In some embodiments, at FIG. 6AN, a swipe input on second history object 668A would display an additional history object for the user to select. At FIG. 6AN, computer system 600 receives input 650AO directed to swap option 668C.

At FIG. 6AO, in response to receiving input 650AO, computer system 600 replaces history object 620F with second history object 668A in fitness summary user interface 620. The replacement causes trends object 620J to move up in fitness summary user interface 620, but the same order is maintained in the arrangement of the objects of fitness summary user interface 620. At FIG. 6AO, while in the edit mode, computer system 600 receives input 650AK (e.g., a tap input, a touch input, an air gesture, a mouse click, a gaze input, and/or a speech input) directed to done option 620I and, in response, exits the edit mode and the objects of fitness summary user interface 620 stop jiggling.

FIG. 7 is a flow diagram illustrating a method for managing activity tracking using a computer system, in accordance with some embodiments. Method 700 is performed at a computer system (e.g., 100, 300, 500, and/or 600) (e.g., a smartphone, a smartwatch, a tablet computer, a laptop computer, a desktop computer, and/or a head mounted device (e.g., a head mounted augmented reality and/or extended reality device)) that is in communication with one or more activity sensors (e.g., location (e.g., GPS) sensor, a motion sensor, an accelerometer, a gyroscope, and/or a heart rate sensor) and one or more one or more input devices (e.g., a touch-sensitive surface, a physical button, a rotatable input mechanism, a rotatable and depressible input mechanism, a keyboard, a controller, and/or a mouse). Some operations in method 700 are, optionally, combined, the orders of some operations are, optionally, changed, and some operations are, optionally, omitted.

As described below, method 700 provides an intuitive way for managing activity tracking. The method reduces the cognitive burden on a user for managing activity tracking, thereby creating a more efficient human-machine interface. For battery-operated computing devices, enabling a user to manage activity tracking faster and more efficiently conserves power and increases the time between battery charges.

During a first time period (e.g., FIG. 6A-6D), the computer system (e.g., 600) operates (702) in a first mode of operation (e.g., a mode in which activity tracking is not paused and/or activity tracking is enabled) that includes tracking (e.g., based on being in the first mode of operation) a plurality of types of physical activities, including tracking a first type of activity (e.g., running and/or walking) and tracking a second type of activity (e.g., swimming and/or standing for at least a threshold (e.g., 5 second, 3 minutes, or 10 minutes) amount of time), of a user of the computer system, including: detecting (704) (e.g., based on being in the first mode of operation), via the one or more activity sensors (e.g., via the location (e.g., GPS) sensor, the motion sensor, the accelerometer, the gyroscope, and/or the heart rate sensor), first activity data corresponding to (e.g., information about the type, frequency, and/or duration of physical activity performed or being performed by) physical activities of the user of the computer system while the computer system is operating in the first mode of operation; and updating (706) (e.g., based on being in the first mode of operation), based on the first activity data, activity metrics (e.g., 608 and/or 610) for the plurality of types of physical activities, including updating a first activity metric (e.g., calories burned and/or number of steps taken) (e.g., for the first and/or second type of activity (e.g., running and/or walking)) and updating a second activity metric (e.g., different from the first activity metric, number of exercise minutes, and/or number of hours during which the user was standing for at least a threshold (e.g., 5 second, 3 minutes, or 10 minutes) amount of time) (e.g., for the first and/or second type of activity).

While operating in the first mode of operation, the computer system receives (708), via one or more input devices, one or more user inputs (e.g., 650H and/or 650E-650H) corresponding to a request to transition to a second mode of operation (e.g., a mode in which activity tracking is paused and/or activity tracking is not enabled), different from the first mode of operation (e.g., for a period of time, for the current day, for the current week, for 10 days, or for the current month).

In response to receiving the one or more user inputs (e.g., 650H and/or 650E-650H) corresponding to the request to transition to the second mode of operation, the computer system transitions (710) (e.g., at FIG. 6J) to operating in the second mode of operation that does not include (e.g., based on being in the second mode of operation) tracking the plurality of types of physical activities of the user of the computer system;

During a second time period (e.g., FIGS. 6J-6M) that is different from the first time period, the computer system (e.g., 600) operates (712) in the second mode of operation that does not include (e.g., based on being in the second mode of operation) tracking the plurality of types of physical activities of the user of the computer system (e.g., forgoing receiving activity data corresponding to physical activities of the user and/or forgoing updating activity metrics for the plurality of types of physical activities based on activity data received during the second mode of operation); In some embodiments, the computer system forgoes tracking the plurality of types of physical activities of the user of the computer system by either (1) receiving activity data and not updating activity metrics based on the activity data (e.g., for one or more activity tracking features, while optionally continuing to update other activity tracking features) or (2) not receiving activity data and not updating activity metrics.

While operating in the second mode of operation, the computer system (e.g., 600) detects (714) (e.g., at FIG. 6O) an end of a period of time (e.g., a period of time received as part of the request to transition to the second mode of operation or an updated period of time that is different than the period of time received with the request to transition to the second mode of operation).

In response to detecting the end of the period of time, the computer system transitions (716) (e.g., at FIG. 6O) to operating in the first mode of operation (e.g., automatically, without requiring further user input, and/or without receiving further user input) that includes tracking (e.g., based on being in the first mode of operation) the plurality of types of physical activities of the user of the computer system. In some embodiments, the computer system receives (e.g., based on being in the first mode of operation), via the one or more activity sensors (e.g., via the location (e.g., GPS) sensor, the motion sensor, the accelerometer, the gyroscope, and/or the heart rate sensor), activity data corresponding to (e.g., information about the type, frequency, and/or duration of physical activity performed or being performed by) physical activities of the user of the computer system. In response to receiving the activity data corresponding to the physical activities of the user of the computer system: in accordance with a determination that the computer system is operating in the first mode of operation, updating, based on the activity data, activity metrics for the plurality of types of physical activities; and in accordance with a determination that the computer system is operating in the second mode of operation, forgoing updating, based on the activity data, activity metrics for the plurality of types of physical activities. Transitioning the computer system from operating in the first mode of operation to operating in the second mode of operation enables the computer system to forgo tracking the plurality of types of physical activities of the user of the computer system, thereby reducing battery usage. Automatically transitioning the computer system to operating in the first mode of operation when an end of a period of time is detected enables the computer system to switch back to tracking the plurality of types of physical activities of the user of the computer system without the need for the user to provide additional input or to remember to perform a task, thereby reducing the number of inputs required and making the process more reliable.

In accordance with some embodiments, prior to receiving the one or more user inputs corresponding to the request to transition to the second mode of operation: the computer system detects (e.g., based on being in the first mode of operation), via the one or more activity sensors (e.g., via the location (e.g., GPS) sensor, the motion sensor, the accelerometer, the gyroscope, and/or the heart rate sensor), activity data corresponding to (e.g., information about the type, frequency, and/or duration of physical activity performed or being performed by) physical activities of the user of the computer system (e.g., 600) while the computer system is operating in the first mode of operation; and the computer system updates (e.g., based on being in the first mode of operation), based on the activity data, activity metrics for the plurality of types of physical activities, including updating the first activity metric (e.g., for the first and/or second type of activity) and updating the second activity metric (e.g., for the first and/or second type of activity). In some embodiments, in response to receiving the one or more user inputs (e.g., 650H and/or 650E-650H) corresponding to the request to transition to the second mode of operation, the computer system updates, based on the activity data, activity metrics for the plurality of types of physical activities to exclude some of the activity data. In some embodiments, the computer system excludes some activity data from the activity metrics for activity data detected prior to receiving the one or more user inputs corresponding to the request to transition to the second mode of operation. For example, the computer system updates the activity metrics to exclude activity data for earlier in the day, for earlier in the week, and/or earlier in the month (in addition to not tracking activity data moving forward). Updating the activity metrics to exclude activity data previously detected when transitioning to the second mode of operation enables the computer system to avoid tracking the plurality of types of physical activities of the user of the computer system for times before the one or more user inputs corresponding to the request to transition to the second mode of operation are received, thereby providing an improved man-machine experience.

In some embodiments, prior to receiving the one or more user inputs (e.g., 650H and/or 650E-650H) corresponding to the request to transition to the second mode of operation (e.g., while in the first mode of operation), the computer system (e.g., 600) monitors an activity streak (e.g., corresponding to 620E) (e.g., the number of days that a respective goal for a respective activity has been met without any intervening days of not meeting the respective goal) that is based on the first activity metric, wherein the activity streak is active when the one or more user inputs corresponding to the request to transition to the second mode of operation is received. In some embodiments, the computer system (e.g., 600) maintains the activity streak during the period of time (e.g., throughout FIGS. 6J-6N) that the computer system (e.g., 600) operates in the second mode of operate, independent of an amount and/or timing of physical activity (e.g., first type of activity and/or second type of activity) detected while the computer system (e.g., 600) operates in the second mode of operate. In some embodiments, an activity streak that is active when the computer system transitions to the second mode of operation is not terminated during the second mode of operation and the computer system extends the count (e.g., number of days and/or number of weeks) of the activity streak after the computer system transitions back to the first mode of operation. Maintaining an activity streak across the period of time when the computer system is operating in the second mode of operation enables the computer system to log a streak of activity over time that reflects the lifestyle and life events of the user, thereby providing an improved man-machine interface.

In some embodiments, in response to receiving the one or more user inputs (e.g., 650H and/or 650E-650H) corresponding to the request to transition to the second mode of operation, the computer system (e.g., 600) updates (e.g., via one or more display generation components) a graphical representation (e.g., 610 at FIGS. 6J, 6L-6N) of activity progress towards one or more goals, including changing the graphical representation of activity progress from a color graphical representation (e.g., including a plurality of colors, such as red, yellow, green, and/or blue) to a grayscale representation (e.g., including different shades of gray without including other colors). Changing the graphical representation of activity progress from a color graphical representation to a grayscale representation provides the user with visual feedback that the computer system is transitioning to the second mode of operation, thereby providing improved visual feedback.

In some embodiments, the graphical representation (e.g., 610 at FIGS. 6J, 6L-6N) of activity progress towards one or more goals is updated to the grayscale representation prior to receiving user input indicating a duration for which the computer system should operation in the second mode of operation. Changing the graphical representation of activity progress from a color graphical representation to a grayscale representation provides the user with visual feedback that the computer system is transitioning to the second mode of operation, thereby providing improved visual feedback.

In some embodiments, the computer system (e.g., 600) is configured to communicate with one or more display generation components (e.g., 602) (e.g., one or more display controllers, displays, touch-sensitive display systems, touchscreens, monitors, and/or a head mounted display system). In some embodiments, updating the graphical representation of activity progress includes: displaying, via the one or more display generation components (e.g., 602), an animation of the graphical representation (e.g., 610) of activity progress transitioning from (e.g., reverting) indicating completion of one or more respective goals to indicating no progress towards completion of the one or more respective goals (e.g., as in FIGS. 6E-6G). In some embodiments, a multi-ring activity progress indicator is displayed filled in (goals reached) and then transitions to not being filled in (no progress made towards goals). Changing the graphical representation of activity progress to indicate no progress towards completion of one or more goals provides the user with visual feedback that the computer system is transitioning to the second mode of operation, thereby providing improved visual feedback.

In some embodiments, the computer system (e.g., 600) is configured to communicate with one or more display generation components (e.g., 602) (e.g., one or more display controllers, displays, touch-sensitive display systems, touchscreens, monitors, and/or a head mounted display system). In some embodiments, the computer system (e.g., 600) receives, via the one or more input devices, user input corresponding to a request to view activity metrics. In response to receiving the user input corresponding to the request to view activity metrics, the computer system (e.g., 600) displays, via the one or more display generation components (e.g., 602), a user interface that includes a graphical representation (e.g., a graphical representation of activity progress towards one or more goals, such as in the form of one or more rings), including: in accordance with a determination that the computer system (e.g., 600) is operating in the first mode of operation, a graphical representation (e.g., 608 and/or 610 at FIGS. 6A-6C, 6O, 6AA, and/or 6AE) that indicates progress of the first activity metric (e.g., detected first activity) towards a first activity goal and progress of the second activity metric (e.g., detected second activity) towards a second activity goal that is different from the first activity goal; and in accordance with a determination that the computer system (e.g., 600) is operating in the second mode of operation, a graphical representation (e.g., 608 and/or 610 at FIGS. 6J, 6L-6N) that does not indicate progress towards the first activity goal (e.g., the is grayed out) and does not indicate progress towards the second activity goal (e.g., is grayed out). Displaying the graphical representation of activity progress differently based on the mode of operation provides the user with visual feedback about the mode of operation in which the computer system operating, thereby providing improved visual feedback.

In some embodiments, the user interface is a lock screen user interface (e.g., 605 at FIGS. 6A, 6M, 6N, and/or 6O) of the computer system (e.g., 600) (e.g., that is displayed while the computer system is in a locked state).

In some embodiments, the user interface includes a multi-day view (e.g., 622 at FIG. 6D) that includes: a representation (e.g., 622A) of a first day (e.g., that the computer system was operating in the first mode of operation) that indicates progress of the first activity metric (e.g., towards a respective activity goal) and/or progress of the second activity metric (e.g., towards a respective activity goal) for the first day and a representation (e.g., 622G, if activity tracking was paused at FIG. 6D) of a second day (e.g., that the computer system was operating in the second mode of operation) that does not indicate progress of the first activity metric (e.g., towards a respective activity goal) and/or progress of the second activity metric (e.g., towards a respective activity goal) for the second day. Displaying representations of different days with different indications of progress towards of activity metrics provides the user with visual feedback about which days the computer system was operating in the first mode of operation (e.g., tracking is active) and in which days the computer system was operating in the second mode of operation (e.g., tracking is paused).

In some embodiments, the one or more user inputs corresponding to the request to transition to the second mode of operation include selection (e.g., 650G and/or 650H) of a period of time (e.g., today, this week, and/or this month) to operate in the second mode of operation. Providing the user with different options for the period of time to operate in the second mode of operation enables the computer system to be personalized to the user's needs, thereby providing an improved man-machine interface.

In some embodiments, the computer system (e.g., 600) is configured to communicate with one or more display generation components (e.g., 602) (e.g., one or more display controllers, displays, touch-sensitive display systems, touchscreens, monitors, and/or a head mounted display system). In some embodiments, while operating in the second mode of operation, the computer system (e.g., 600) displays, via the one or more display generation components (e.g., 602), a notification (e.g., 604A) indicating when the computer system (e.g., 600) will transition to operating in the first mode of operation and continue tracking of the plurality of types of physical activities when the period of time ends (e.g., expires and/or passes). In some embodiments, the notification is displayed the day prior to the period of time ending. In some embodiments, the notification is displayed 24 hours prior to the period of time ending. Providing a notification indicating when computer system will transition to operating in the first mode of operation provides the user with visual feedback about the state of the computer system and when the mode of operation will change, thereby providing improved visual feedback.

In some embodiments, the computer system (e.g., 600) is configured to communicate with one or more display generation components (e.g., 602) (e.g., one or more display controllers, displays, touch-sensitive display systems, touchscreens, monitors, and/or a head mounted display system). In some embodiments, while operating in the second mode of operation, the computer system (e.g., 600) displays, via the one or more display generation components, an option (e.g., 650L and/or 632C at FIG. 6K) to extend a respective period of time at the end of which the computer system will transition from operating in the second mode of operation to operating in the first mode of operation. In some embodiments, the computer system receives one or more user inputs that include activation of the option to extend the respective period of time and, in response, the computer system extends the period of time. In some embodiments, the length of the extension of the period of time is based on the user inputs. Providing the user with an option to extend the period of time for the computer system to operate in the second mode of operation provides the user with options for controlling the operating mode of the computer system while reducing the number of inputs required, thereby improving the man-machine interface.

In some embodiments, the computer system (e.g., 600) is configured to communicate with one or more display generation components (e.g., 602) (e.g., one or more display controllers, displays, touch-sensitive display systems, touchscreens, monitors, and/or a head mounted display system). In some embodiments, while operating in the second mode of operation, the computer system (e.g., 600) displays, via the one or more display generation components and concurrently (e.g., at FIG. 6K) with the option (e.g., 632C) to extend the respective period of time, an option (e.g., 632B) to transition from operating in the second mode of operation to operating in the first mode of operation and continue tracking of the plurality of types of physical activities. In some embodiments, the computer system receives one or more user inputs that include activation of the option to transition from operating in the second mode of operation to operating in the first mode of operation, and in response, the computer system transitions to operating in the first mode of operation (e.g., and, therefore, begins to again track the plurality of types of physical activities). Providing the user with an option to resume operating in the first mode of operation provides the user with options for controlling the operating mode of the computer system while reducing the number of inputs required, thereby improving the man-machine interface.

In some embodiments, the computer system (e.g., 600) is configured to communicate with one or more display generation components (e.g., 602) (e.g., one or more display controllers, displays, touch-sensitive display systems, touchscreens, monitors, and/or a head mounted display system). In some embodiments, in accordance with a determination that the period of time has ended, the computer system (e.g., 600) displays, via the one or more display generation components (e.g., 602), an indication (e.g., 604D) that the computer system (e.g., 600) is transitioning to operating in the first mode of operation (e.g., and, therefore, will continue tracking of the plurality of types of physical activities). In some embodiments, in accordance with a determination that the period of time has not ended, the computer system forgoes displaying the indication that the computer system is transitioning to operating in the first mode of operation. Providing the user with the indication that the computer system is transitioning to operating in the first mode of operation provides the user with visual feedback about the state of the computer system, thereby providing improved visual feedback.

Note that details of the processes described above with respect to method 700 (e.g., FIG. 7) are also applicable in an analogous manner to the methods described below. For example, methods 800 and 900 optionally include one or more of the characteristics of the various methods described above with reference to method 700. For brevity, these details are not repeated below.

FIG. 8 is a flow diagram illustrating methods of managing activity goals, in accordance with some embodiments. Method 800 is performed at a computer system (e.g., 100, 300, 500, and/or 600) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 602) (e.g., one or more display controllers, displays, touch-sensitive display systems, touchscreens, monitors, and/or a head mounted display system) and one or more one or more input devices (e.g., a touch-sensitive surface, a physical button, a rotatable input mechanism, a rotatable and depressible input mechanism, a keyboard, a controller, and/or a mouse). Some operations in method 800 are, optionally, combined, the orders of some operations are, optionally, changed, and some operations are, optionally, omitted.

As described below, method 800 provides an intuitive way for managing activity goals. The method reduces the cognitive burden on a user for managing activity goals, thereby creating a more efficient human-machine interface. For battery-operated computing devices, enabling a user to manage activity goals faster and more efficiently conserves power and increases the time between battery charges.

The computer system (e.g., 600) receives (802), via the one or more input devices, a request (e.g., 650O at FIG. 6Q) to display an activity schedule user interface (e.g., 636 at FIG. 6R) for a first activity metric (e.g., calories burned, minutes of exercise, steps taken, distance run, and/or stand hours).

In response to receiving the request (e.g., 650O at FIG. 6Q) to display the activity schedule user interface for the first activity metric, the computer system (e.g., 600) displays (804), via the one or more display generation components (e.g., 602), the activity schedule user interface (e.g., 636) for the first activity metric, including concurrently displaying: a first activity goal (e.g., 380 Cal for 636B) for the first activity metric for a first day; a first object (e.g., 636H) for modifying the first activity goal for the first activity metric for the first day (e.g., Monday) (e.g., a day of the week and/or a day of the month) (and, optionally, not for other days, such as for the second day, for other days of the week, or for other days of the month); a second activity goal (e.g., 380 Cal for 636C) for the first activity metric for a second day (e.g., Tuesday) that is different from the first day; and a second object (e.g., 636I) for modifying the second activity goal for the first activity metric for the second day (e.g., Tuesday) (e.g., a day of the week and/or a day of the month) (and, optionally, not for other days, such as for the first day, for other days of the week, or for other days of the month).

While displaying the activity schedule user interface (e.g., 636A) for the first activity metric, the computer system (e.g., 600) receives (806), via the one or more input devices, a first input (e.g., input directed to 636H or input directed to 636I) (and/or a first set of inputs).

In response (808) to receiving the first input (and/or the first set of inputs), in accordance with a determination that the first input is directed to the first object (e.g., input directed to 636H at FIG. 6R) (e.g., an increase option of the first object or a decrease option of the first object), the computer system (e.g., 600) modifies (810) the first activity goal for the first activity metric for the first day without modifying the second activity goal for the first activity metric for the second day.

In response (808) to receiving the first input (and/or the first set of inputs), in accordance with a determination that the first input is directed to the second object (e.g., input directed to 636I) (e.g., an increase option of the second object or a decrease option of the second object), the computer system (e.g., 600) modifies (812) the second activity goal for the first activity metric for the second day without modifying the first activity goal for the first activity metric for the first day. Enabling users to modify a respective activity goal for a first day without modifying the respective activity goal for a second day provides the user with additional control over the activity tracking and progress towards activity goals, thereby improving the man-machine interface.

In some embodiments, the computer system (e.g., 600) displays, via the one or more display generation components (e.g., 602), a weekly activity user interface (e.g., 634 at FIG. 6Q) that includes a weekly adjustment object (e.g., 634B and/or 634C) for modifying an activity goal for the first activity metric for a plurality of days (e.g., all days of the week, all weekdays, and/or all weekend days), including the first day and the second day. Providing the user with a weekly activity user interface that allows modifying activity goals for the week (e.g., without the ability to change daily activity goals) enables the user to more quickly set activity goals that are consistent across multiple days, thereby improving the man-machine interface.

In some embodiments, the computer system (e.g., 600) receives, via the one or more input devices, an input (e.g., 650N) directed to the weekly adjustment object (e.g., 634B and/or 634C). In response to receiving the input directed to the weekly adjustment object, the computer system (e.g., 600) modifies the activity goal for the first activity metric for the first day and the second day. In some embodiments, the weekly activity user interface enables the user to use the same activity goal for the first activity metric for all days of the week. In some embodiments, the weekly adjustment object enables the user to simultaneously modify the activity goal for the first activity metric for all days of the week. Providing the user with a weekly activity user interface that allows modifying activity goals for the week (e.g., without the ability to change daily activity goals) enables the user to more quickly set activity goals that are consistent across multiple days, thereby improving the man-machine interface.

In some embodiments, the activity schedule user interface (e.g., 636 at FIG. 6S) for the first activity metric includes a weekly schedule option (e.g., 636A). In response to receiving the first input (and/or the first set of inputs) and in accordance with a determination that the first input (e.g., 650Q) is directed to the weekly schedule option, the computer system (e.g., 600): ceases display of the first object (e.g., 636H) for modifying the first activity goal for the first activity metric for the first day and the second object (e.g., 636I) for modifying the second activity goal for the first activity metric for the second day; and displays, via the one or more display generation components, a weekly activity user interface (e.g., 634 at FIG. 6Q) that includes a weekly adjustment object (e.g., 634B and/or 634C) for modifying an activity goal for the first activity metric for a plurality of days (e.g., all days of the week, all weekdays, and/or all weekend days), including the first day and the second day. In some embodiments, the weekly activity user interface does not enable modifying activity goals for individual days, but rather enables modifying activity goals for a plurality of days together (e.g., all days of the week, month, and/or year). Enabling the user to switch between configuring activity goals using the activity schedule user interface and the weekly activity user interface enables the user to configure activity goals on a daily or everyday basis, thereby improving the man-machine interface.

In some embodiments, the computer system (e.g., 600) displays (e.g., while configuring using the activity schedule user interface), via the one or more display generation components, a graphical representation (e.g., 608 and/or 610) of activity progress towards one or more goals, including: in accordance with a determination that a current day is the first day, an indication of progress of the first activity metric towards the first activity goal; and in accordance with a determination that the current day is the second day, an indication of progress of the first activity metric towards the second activity goal. Displaying a graphical representation of activity progress towards one or more goals provides the user with visual feedback about the user's progress towards reaching the one or more goals, thereby providing improved visual feedback.

In some embodiments, the computer system (e.g., 600) monitors an activity streak (e.g., corresponding to the streak at FIG. 6K) (e.g., the number of days that a respective goal for a respective activity has been met without any intervening days of not meeting the respective goal) that is based on the first activity metric, including after the first day (e.g., once the first day has ended): in accordance with a determination that the first activity goal has been met for the first activity metric for the first day, maintaining the activity streak; and in accordance with a determination that the first activity goal has not been met for the first activity metric for the first day, ending the activity streak. In some embodiments, if the activity streak is active during the second day, the computer system monitors the activity streak after the second day, including: in accordance with a determination that the second activity goal has been met for the first activity metric for the second day, maintaining the activity streak; and in accordance with a determination that the second activity goal has not been met for the first activity metric for the second day, ending the activity streak. Maintaining an activity streak for the same activity based on different activity goals for different days enables the computer system to adjust to the user's activity schedule, thereby improving the man-machine interface.

In some embodiments, the computer system (e.g., 600) displays (e.g., while configuring using the activity schedule user interface), via the one or more display generation components (e.g., 602), a graphical representation (e.g., 810) of activity progress towards one or more goals that includes a first path (e.g., outside ring of 810) with a first length, the first path corresponding to the first activity metric, wherein: in accordance with a determination that a current day is the first day, the first length of the first path corresponds to progress towards the first activity goal (e.g., the more the path is filled in, the more progress has been made towards the first activity goal); and in accordance with a determination that a current day is the second day, the first length of the first path corresponds to progress towards the second activity goal (e.g., the more the path is filled in, the more progress has been made towards the second activity goal). Thus, the same path with the same length corresponds to different levels of activity based on the respective activity goal for the current day. Configuring the same path (e.g., the same size ring) to correspond to different amounts of activity for different days based on the respective activity goal for the respective day provides the user with visual feedback about the amount of progress made toward the activity goal without the need for the user to adjust for the different activity goals, thereby providing improved visual feedback.

In some embodiments, the first day corresponds to a first day of each week and the second day corresponds to a second day of each week that is different from the first day of each week. In some embodiments, on the first day of a respective week: the computer system (e.g., 600) displays, via the one or more display generation components, an option (e.g., 628A at FIG. 6Z) to modify a respective activity goal for the first activity metric for the current day; receiving, via the one or more input devices, one or more inputs that includes activation of the option (e.g., 628A) to modify the respective activity goal for the first activity metric for the current day; and in response to receiving the one or more inputs that includes activation of the option to modify the respective activity goal for the first activity metric for the current day, modifying the respective activity goal (e.g., for purposes of a streak and/or for filling the first path of the graphical representation of activity progress) for the current day without modifying the respective activity goal for the first day of other weeks. Enabling the user to adjust the activity goal for the current day without modifying activity goals for other days enables the computer system to provide the user with activity goals and tracking the fits the user's schedule and needs, thereby improving the man-machine interface.

Note that details of the processes described above with respect to method 800 (e.g., FIG. 8) are also applicable in an analogous manner to the methods described above/below. For example, methods 700 and 900 optionally include one or more of the characteristics of the various methods described above with reference to method 800. For brevity, these details are not repeated below.

FIG. 9 is a flow diagram illustrating methods of managing activity user interfaces, in accordance with some embodiments. Method 700 is performed at a computer system (e.g., 100, 300, 500, and/or 600) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 602) (e.g., one or more display controllers, displays, touch-sensitive display systems, touchscreens, monitors, and/or a head mounted display system) and one or more one or more input devices (e.g., a touch-sensitive surface, a physical button, a rotatable input mechanism, a rotatable and depressible input mechanism, a keyboard, a controller, and/or a mouse). Some operations in method 900 are, optionally, combined, the orders of some operations are, optionally, changed, and some operations are, optionally, omitted.

As described below, method 900 provides an intuitive way for managing activity user interfaces. The method reduces the cognitive burden on a user for managing activity user interfaces, thereby creating a more efficient human-machine interface. For battery-operated computing devices, enabling a user to manage activity user interfaces faster and more efficiently conserves power and increases the time between battery charges.

The computer system (e.g., 600) displays (902), via the one or more display generation components (e.g., 602), a plurality of objects (e.g., cards and/or widgets) in a first mode (e.g., an edit mode, a mode in which the plurality of objects can be edited, such as by being moved and/or resized), wherein the plurality of objects (e.g., 620B, 620C, 620F at FIG. 6AG) (e.g., that correspond to different types of activities) includes: a first object (e.g., 620B) corresponding to a first activity (e.g., running, walking, and/or swimming) and including a first set of information (e.g., information about a first metric (e.g., time), a first type of information, and/or information with a first scope) about the first activity (e.g., time spent performing the first activity), and a second object (e.g., 620C and/or 620F), different from the first object (e.g., 620B), corresponding to a second activity (e.g., running, walking, and/or swimming; that is optionally the same as or that is different from the first activity) and including a second set of information (e.g., information about a second metric (e.g., distance), a second type of information and/or information with a second scope) about the second activity (e.g., distance covered performing the second activity).

While displaying the plurality of objects in the first mode and while the first object includes the first set of information about the first activity (e.g., including the first set of information about the first activity without including a third set of information about the first activity), the computer system (e.g., 600) receives (904), via the one or more input devices, an input (e.g., 650AL and/or 648A) (e.g., a touch input, a tap input, a gesture, an air gesture) directed to (e.g., on and/or towards) the first object (e.g., 620B).

In response to receiving the input directed to the first object, the computer system (e.g., 600) initiates (906) a process to modify the first object (e.g., 620B) without initiating a process to modify the second object (e.g., 620C and/or 620F) (and, optionally, without initiating a process to modify other objects of the plurality of objects);

During the process to modify the first object, the computer system (e.g., 600) receives (908), via the one or more input devices, one or more inputs (e.g., 650I and/or 650AJ) to modify the first object (e.g., 620B to 666B at FIG. 6AK), including one or more inputs to modify the first set of information about the first activity to a third set of information (e.g., information about the first metric (e.g., time), the first type of information, and/or information with a second scope) about the first activity (e.g., including the third set of information about the first activity without including the first set of information about the first activity, including more information about the first activity, including less information about the first activity, and/or including different information about the first activity) that is different from the first set of information about the first activity.

Subsequent to the process to modify the first object, the computer system (e.g., 600) displays (910), via the one or more display generation components (e.g., 602), the plurality of objects (e.g., at FIG. 6AK), including the first object (e.g., 666B) with the third set of information about the first activity (e.g., concurrently with the second object with the second set of information about the second activity). Modify objects of the plurality of objects based on user inputs enables the computer system to customize the plurality of objects for the benefit of the user, thereby providing the user with improved visual feedback with the information that the user wants to review.

In some embodiments, the one or more inputs to modify the first object include one or more inputs to modify a shape of the first object (e.g., as illustrated with respect to 620F and 668 at FIGS. 6AK-6AO). Subsequent to the process to modify the first object, the first object is displayed with the modified shape. In some embodiments, the first object has a first shape prior to the process to modify the first object and the first object has a second shape, different from the first shape, subsequent to the process to modify the first object. Modify the shape of objects of the plurality of objects based on user inputs enables the computer system to customize the plurality of objects for the benefit of the user, thereby providing the user with improved visual feedback with the information that the user wants to review.

In some embodiments, the one or more inputs to modify the first object include one or more inputs to modify a size of the first object (e.g., as illustrated with respect to 620F and 668 at FIGS. 6AK-6AO). Subsequent to the process to modify the first object, the first object is displayed with the modified size. In some embodiments, the first object has a first size prior to the process to modify the first object and the first object has a second size, different from the first size, subsequent to the process to modify the first object. Modify the size of objects of the plurality of objects based on user inputs enables the computer system to customize the plurality of objects for the benefit of the user, thereby providing the user with improved visual feedback with the information that the user wants to review.

In some embodiments, the plurality of objects includes a graphical representation (e.g., 620A) of activity progress towards one or more goals. While displaying the plurality of objects in the first mode, the computer system (e.g., 600) receives, via the one or more input devices, an input (e.g., a touch input, a tap input, a gesture, an air gesture) directed to (e.g., on and/or towards) the graphical representation (e.g., 620A at FIG. 6AO) of activity progress towards one or more goals. In response to receiving the input directed to the graphical representation of activity progress towards one or more goals, the computer system (e.g., 600) forgoes initiating a process to modify the graphical representation of activity progress towards one or more goals. In some embodiments, the location, size, and/or contents of the graphical representation of activity progress towards one or more goals cannot be changed while in the first mode. Limiting (e.g., preventing) users from modifying the graphical representation of activity progress towards one or more goals enables the computer system to provide relevant feedback to the user about activity progress, thereby providing improved visual feedback.

In some embodiments, prior to receiving the input directed to the first object, the plurality of objects (e.g., cards and/or widgets) are displayed in a respective arrangement (e.g., at FIG. 6AE) (e.g., at respective locations in the user interface with respect to each other). Subsequent to the process to modify the first object, the plurality of objects are displayed in the respective arrangement (e.g., at FIG. 6AK). In some embodiments, the arrangement (e.g., order and/or positions) of the plurality of objects is maintained before and after modifying an object. Modifying the first object while maintaining the respective arrangement enables the computer system to provide the user with options for modifying the plurality of objects while making is easy to find and review the objects, thereby improving the man-machine interface.

In some embodiments, the computer system receives one or more inputs to transition the computer system to a second mode that is different from the first mode. In some embodiments, the computer system (e.g., 600) displays, via the one or more display generation components (e.g., 602), the plurality of objects (e.g., cards and/or widgets) in a second mode (e.g., at FIG. 6AA) (e.g., a viewing mode, a mode in which the plurality of objects cannot be edited), wherein the plurality of objects (e.g., that correspond to different types of activities) includes the first object (e.g., 620B) corresponding to the first activity and the second object (e.g., 620C) corresponding to the second activity. While displaying the plurality of objects in the second mode, the computer system (e.g., 600) receives, via the one or more input devices, a second input (e.g., 650Z and/or 650AB) (e.g., a touch input, a tap input, a gesture, an air gesture) directed to (e.g., on and/or towards) the first object. In response to receiving the second input directed to the first object, the computer system (e.g., 600) forgoes initiating the process to modify the first object (and forgoing initiating a process to modify the second object). Operating the computer system in the second mode enables the computer system to not initiate a process to modify a respective object when an input is directed at the object, thereby reducing the chances of the user unintentionally modifying an object and improving the man-machine interface.

In some embodiments, in response to receiving the second input (e.g., 650Z and/or 650AB) directed to the first object, the computer system (e.g., 600) displays, via the one or more display generation components (e.g., by replacing display of the plurality of objects), a detail user interface (e.g., 660 and/or 664) that includes detailed information about the first activity (e.g., amount of first activity, daily breakdown of first activity, progress of first activity towards respective (e.g., daily) goal(s), and/or different information from the first object and/or more information than included in the first object). In some embodiments, the details user interface also includes information (e.g., detailed information) about the second activity. Displaying additional information (e.g., detail information) about the first activity provides the user with more information about how much first activity has been tracked by the computer system, thereby providing improved visual feedback.

In some embodiments, objects (e.g., 620B and 620C at FIG. 6AA) of the plurality of objects are displayed in a respective arrangement and an order of information (e.g., order of detailed information about the first activity and detailed information about the second activity) of the detail user interface (e.g., 660 at FIG. 6AB) is based on an order of objects in the respective arrangement (e.g., 660A is displayed above 660B in FIG. 6AB because 620B is displayed to the left of 620C in FIG. 6AA). In some embodiments, the detail user interface includes detailed information about the first activity above detailed information about the second activity because the arrangement of the plurality of objects includes the first object (corresponding to the first activity) earlier in the arrangement than the second object (corresponding to the second activity). Displaying information of the detail user interface in an order that is based on the order of objects in the arrangement enables the computer system to display the detail user interface with content ordered based on the user's preferences, thereby providing the user with easier access to the information and providing improved visual feedback.

In some embodiments, while displaying the plurality of objects in the second mode, the computer system (e.g., 600) receives, via the one or more input devices, a third input (e.g., 650AA) (e.g., a touch input, a tap input, a gesture, an air gesture) directed to (e.g., on and/or towards) the second object. In response to receiving the third input (e.g., 650AA) directed to the second object, the computer system (e.g., 600) displays, via the one or more display generation components (e.g., 602) (e.g., by replacing display of the plurality of objects), the detail user interface (e.g., 660) that includes detailed information about the first activity (e.g., different information from the first object and/or more information than included in the first object). In some embodiments, the details user interface also includes information (e.g., detailed information) about the second activity. Displaying the same detail user interface when the computer system receives an input directed to the second object enables the computer system to display the same user interface when either object is selected (e.g., because the detail user interface includes details about both the first activity and the second activity), thereby providing improved visual feedback.

In some embodiments, while displaying the plurality of objects in the first mode, the computer system (e.g., 600) displays, via the one or more display generation components (e.g., 602), an option (e.g., 648B at FIG. 6AH) to initiate a process to delete the first object (e.g., 620B) (and, optionally, an option to initiate a process to delete the second object); In some embodiments, the option to initiate the process to delete the first object is displayed in response to receiving, via the one or more input devices, the input (e.g., a touch input, a tap input, a gesture, an air gesture) directed to (e.g., on and/or towards) the first object. While displaying the option (e.g., 648B) to initiate the process to delete the first object, the computer system (e.g., 600) receives, via the one or more input devices, an input directed to the option to initiate a process to delete the first object. In response to receiving the input directed to the option to initiate a process to delete the first object, the computer system (e.g., 600) initiates a process to delete the first object (e.g., deleting the first object and/or requesting confirmation to delete the first object). In some embodiments, the option to initiate a process to delete the first object (or a respective object) is not displayed while the plurality of objects are displayed in the second mode. Providing an option to delete a respective object enables the computer system to provide the user with the ability to better organize the objects and specify which objects should be displayed, thereby providing improved visual feedback.

In some embodiments, while displaying the plurality of objects in the first mode, the computer system (e.g., 600) receives, via the one or more input devices, a movement input (e.g., a drag input, a touch input, an air gesture, and/or an input that includes movement) directed to first object. In response to receiving the movement input directed to the first object, moving, via the one or more display generation components, the first object within an arrangement of the plurality of objects (e.g., rearranging the arrangement of the plurality of objects by moving the first object within the arrangement). Enabling the computer system to change a location of an object within the arrangement allows the user to better personalize the arrangement to their preferences based on their needs, thereby providing improved visual feedback and improving the man-machine interface.

Note that details of the processes described above with respect to method 900 (e.g., FIG. 9) are also applicable in an analogous manner to the methods described below. For example, methods 700 and 800 optionally include one or more of the characteristics of the various methods described above with reference to method 700. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve physical activity user interfaces. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to display physical activity user interfaces. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer system that is configured to communicate with one or more activity sensors and one or more one or more input devices, the computer system comprising:
one or more processors; and
memory storing one or more programs configured to be executed by the one or more processors, the one or more programs including instructions for:
during a first time period, operating in a first mode of operation that includes tracking a plurality of types of physical activities, including tracking a first type of activity and tracking a second type of activity, of a user of the computer system, including:
detecting, via the one or more activity sensors, first activity data corresponding to physical activities of the user of the computer system while the computer system is operating in the first mode of operation; and
updating, based on the first activity data, activity metrics for the plurality of types of physical activities, including updating a first activity metric and updating a second activity metric;
while operating in the first mode of operation, receiving, via one or more input devices, one or more user inputs corresponding to a request to transition to a second mode of operation, different from the first mode of operation;
in response to receiving the one or more user inputs corresponding to the request to transition to the second mode of operation, transitioning to operating in the second mode of operation that does not include tracking the plurality of types of physical activities of the user of the computer system;
during a second time period that is different from the first time period, operating in the second mode of operation that does not include tracking the plurality of types of physical activities of the user of the computer system;
while operating in the second mode of operation, detecting an end of a period of time; and
in response to detecting the end of the period of time, transitioning to operating in the first mode of operation that includes tracking the plurality of types of physical activities of the user of the computer system.

2. The computer system of claim 1, the one or more programs further including instructions for:
prior to receiving the one or more user inputs corresponding to the request to transition to the second mode of operation:
detecting, via the one or more activity sensors, activity data corresponding to physical activities of the user of the computer system while the computer system is operating in the first mode of operation; and
updating, based on the activity data, activity metrics for the plurality of types of physical activities, including updating the first activity metric and updating the second activity metric; and
in response to receiving the one or more user inputs corresponding to the request to transition to the second mode of operation, updating, based on the activity data, activity metrics for the plurality of types of physical activities to exclude some of the activity data.

3. The computer system of claim 1, the one or more programs further including instructions for:
prior to receiving the one or more user inputs corresponding to the request to transition to the second mode of operation, monitoring an activity streak that is based on the first activity metric, wherein the activity streak is active when the one or more user inputs corresponding to the request to transition to the second mode of operation is received; and
maintaining the activity streak during the period of time that the computer system operates in the second mode of operate, independent of an amount and/or timing of physical activity detected while the computer system operates in the second mode of operate.

4. The computer system of claim 1, the one or more programs further including instructions for:
in response to receiving the one or more user inputs corresponding to the request to transition to the second mode of operation, updating a graphical representation of activity progress towards one or more goals, including changing the graphical representation of activity progress from a color graphical representation to a grayscale representation.

5. The computer system of claim 4, wherein the graphical representation of activity progress towards one or more goals is updated to the grayscale representation prior to receiving user input indicating a duration for which the computer system should operation in the second mode of operation.

6. The computer system of claim 4, wherein the computer system is configured to communicate with one or more display generation components and wherein updating the graphical representation of activity progress includes:
displaying, via the one or more display generation components, an animation of the graphical representation of activity progress transitioning from indicating completion of one or more respective goals to indicating no progress towards completion of the one or more respective goals.

7. The computer system of claim 1, wherein the computer system is configured to communicate with one or more display generation components, the one or more programs further including instructions for:
receiving, via the one or more input devices, user input corresponding to a request to view activity metrics; and
in response to receiving the user input corresponding to the request to view activity metrics, displaying, via the one or more display generation components, a user interface that includes a graphical representation, including:
in accordance with a determination that the computer system is operating in the first mode of operation, a graphical representation that indicates progress of the first activity metric towards a first activity goal and progress of the second activity metric towards a second activity goal that is different from the first activity goal; and
in accordance with a determination that the computer system is operating in the second mode of operation, a graphical representation that does not indicate progress towards the first activity goal and does not indicate progress towards the second activity goal.

8. The computer system of claim 7, wherein the user interface is a lock screen user interface of the computer system.

9. The computer system of claim 7, wherein the user interface includes a multi-day view that includes:
a representation of a first day that indicates progress of the first activity metric and/or progress of the second activity metric for the first day; and
a representation of a second day that does not indicate progress of the first activity metric and/or progress of the second activity metric for the second day.

10. The computer system of claim 1, wherein the one or more user inputs corresponding to the request to transition to the second mode of operation include selection of a period of time to operate in the second mode of operation.

11. The computer system of claim 1, wherein the computer system is configured to communicate with one or more display generation components, the one or more programs further including instructions for:
while operating in the second mode of operation, displaying, via the one or more display generation components, a notification indicating when the computer system will transition to operating in the first mode of operation and continue tracking of the plurality of types of physical activities when the period of time ends.

12. The computer system of claim 1, wherein the computer system is configured to communicate with one or more display generation components, the one or more programs further including instructions for:
while operating in the second mode of operation, displaying, via the one or more display generation components, an option to extend a respective period of time at the end of which the computer system will transition from operating in the second mode of operation to operating in the first mode of operation.

13. The computer system of claim 12, the one or more programs further including instructions for:
while operating in the second mode of operation, displaying, via the one or more display generation components and concurrently with the option to extend the respective period of time, an option to transition from operating in the second mode of operation to operating in the first mode of operation and continue tracking of the plurality of types of physical activities.

14. The computer system of claim 1, wherein the computer system is configured to communicate with one or more display generation components, the one or more programs further including instructions for:
in accordance with a determination that the period of time has ended, displaying, via the one or more display generation components, an indication that the computer system is transitioning to operating in the first mode of operation.

15. A non-transitory computer-readable storage medium storing one or more programs configured to be executed by one or more processors of a computer system that is in communication with one or more display generation components and one or more one or more input devices, the one or more programs including instructions for:
receiving, via the one or more input devices, a request to display an activity schedule user interface for a first activity metric;
in response to receiving the request to display the activity schedule user interface for the first activity metric, displaying, via the one or more display generation components, the activity schedule user interface for the first activity metric, including concurrently displaying:
a first activity goal for the first activity metric for a first day;
a first object for modifying the first activity goal for the first activity metric for the first day;
a second activity goal for the first activity metric for a second day that is different from the first day; and
a second object for modifying the second activity goal for the first activity metric for the second day;
while displaying the activity schedule user interface for the first activity metric, receiving, via the one or more input devices, a first input; and
in response to receiving the first input:
in accordance with a determination that the first input is directed to the first object, modifying the first activity goal for the first activity metric for the first day without modifying the second activity goal for the first activity metric for the second day; and
in accordance with a determination that the first input is directed to the second object, modifying the second activity goal for the first activity metric for the second day without modifying the first activity goal for the first activity metric for the first day.

16. A method, comprising:
at a computer system that is in communication with one or more activity sensors and one or more one or more input devices:
during a first time period, operating in a first mode of operation that includes tracking a plurality of types of physical activities, including tracking a first type of activity and tracking a second type of activity, of a user of the computer system, including:
detecting, via the one or more activity sensors, first activity data corresponding to physical activities of the user of the computer system while the computer system is operating in the first mode of operation; and
updating, based on the first activity data, activity metrics for the plurality of types of physical activities, including updating a first activity metric and updating a second activity metric;
while operating in the first mode of operation, receiving, via one or more input devices, one or more user inputs corresponding to a request to transition to a second mode of operation, different from the first mode of operation;
in response to receiving the one or more user inputs corresponding to the request to transition to the second mode of operation, transitioning to operating in the second mode of operation that does not include tracking the plurality of types of physical activities of the user of the computer system;
during a second time period that is different from the first time period, operating in the second mode of operation that does not include tracking the plurality of types of physical activities of the user of the computer system;
while operating in the second mode of operation, detecting an end of a period of time; and
in response to detecting the end of the period of time, transitioning to operating in the first mode of operation that includes tracking the plurality of types of physical activities of the user of the computer system.
